(19) United States
(12) Patent Application Publication
(10) Pub. No.: US 2026/0269930 A1
(43) Pub. Date: Sep. 10, 2026

(54) A SATELLITE TRANSMITTER

(71) Applicant: ST ENGINEERING IDIRECT (EUROPE) CY NV, Sint-Niklaas (BE)

(72) Inventors: Daniel DELARUELLE, Sint-Niklaas (BE); Dieter DUYCK, Sint-Niklaas (BE)

(21) Appl. No.: 19/165,778

(22) PCT Filed: Mar. 7, 2024
(86) PCT No.: PCT/EP2024/055942

§ 371 Date: Sep. 16, 2025

(30) Foreign Application Priority Data
Mar. 17, 2023 (EP) 23162578.1

(51) Int. Cl. H04B 7/185; H04L 25/02

(52) U.S. Cl. CPC H04B 7/18515; H04L 25/0228

(57) ABSTRACT

A transmitter is described for generating digital signals for at least two physical carriers to estimate differential time offset. The transmitter includes modulation means that process, for each carrier, a symbol stream organized into superframes, similar to DVB-S2X. Each superframe contains a set of known symbols and at least one physical layer frame. The known symbols include a SOSF field defined by a superframe-specific SOSF index and an SFFI field. The modulation means perform superframe-specific scrambling of at least the SOSF field with a reference scrambler and superframe-specific scrambling of the SFFI field with a payload scrambler. Some superframes are used as estimation frames to determine the time offset difference between the carriers. The payload scrambling indices of the scrambled SFFI field differ across carriers for these estimation frames. Each estimation frame includes a non-precoded signature field, containing parts of both the scrambled SOSF and SFFI fields.

### FIELD OF THE INVENTION

The present invention is generally related to the field of satellite communications, more in particular to a transmitter and multi-beam satellite communication system wherein digital signals are generated for estimating channel information.

### BACKGROUND OF THE INVENTION

High-throughput satellites typically use a multi-beam architecture in order to increase the satellite capacity. The capacity increase results from the reuse of allocated spectrum in different beams. However, where such beams spatially (partially) overlap while sharing frequency and polarization, severe adjacent beam interference occurs, which limits performance. In order to reduce interference and so maximize the throughput, typically a 4-color scheme is used, where the spatially overlapping beams each use a different spectrum resource (different in frequency or polarization, or both). The 4-fold spectrum resource reduction over any given landing point in the forward downlink then again reduces the achievable capacity.

Beam interference acts as a linear recombination of beam signals. Consider for example, the adjacent beam interference of K beam signals towards a set of K simultaneous terminals (one simultaneous terminal per beam, one receive antenna per terminal). The interference among a set of K beam signals towards a set of K simultaneous terminals can be characterized by a K-by-K complex-valued matrix known as the channel matrix H. Note that a terminal refers to RF equipment, comprising one or more receiver antennas, an amplifier and downconverter, and modem equipment. Clearly, multiple users may be served by a single terminal. E.g., a terminal can comprise WiFi technology to which cell phone users can connect in a local network for instance. An example may be a cruise ship with one terminal connecting all passengers (users).

Furthermore, when one considers in the case of a single carrier per beam, carriers with equal symbol rate in adjacent beams that reuse a same flat spectrum resource and when one also ignores, or has compensated for, differential frequency and time offsets, the channel matrix can be thought of as acting directly on the complex-valued symbols (obtained after forward error correcting encoding, mapping and potentially extra symbol processing prior to pulse shaping, such as scrambling) of the equal symbol rate carriers. Thus, a K by 1 vector s of simultaneous symbols (one for each of the K carriers) is, at the receiver antenna of a terminal, transformed to a vector H.s of receive symbols suffering from interference. The performance loss due to this unintentional linear mixing of data symbols is typically larger than the gain of reusing the entire spectrum resources and therefore discourages full frequency reuse compared to 4-color reuse. In other words, without further measures, a 4-color reuse scheme is typically optimal in terms of throughput.

A technique for reducing beam interference (thus improving signal to noise and interference ratio, denoted SNR in the following) under spectrum reuse is linear precoding. The technique of jointly linear precoding K equal symbol rate carriers reusing a spectrum resource then amounts to pre-multiplying the vector s of aligned or simultaneous data symbols by a K-by-K precoding matrix W, resulting in a total transformation of the symbol vector to symbols H.W.s suffering less interference or even enjoying benign constructive interference from different beams, thus promoting full frequency reuse. In this disclosure the term frequency reuse is used interchangeably with spectrum reuse, which refers to the reuse of frequency and polarization, typically. In general, coefficients of channel matrix H are estimated at the receive side, signalled to a precoding system controller that then assembles channel matrix estimates H and computes or selects a precoding matrix W=f(Ĥ) to be used for the linear transformation of data symbol vectors, where W depends on the channel matrix estimate. The computation of a precoding matrix may also take into account signal quality information, for example signal quality measured by at the receiver side. Linear precoding for satellite communications was already introduced in 2005 (see paper “Perspectives of Adopting Interference Mitigation Techniques in the Context of Broadband Multimedia Satellite Systems,” G. Gallinaro et al., ICSSC 2005), where a separate spread spectrum signal sharing the same band as DVB-S2 was proposed as a measurement signal for channel estimation. This requires a separate demodulator just for that signal, which is more costly, but whichever signal is used for measurement, the same challenges as discussed further need to be overcome. After 2005, many academic studies and patents have followed, eventually leading to the standardization of superframes in DVB-S2X (ETSI EN 302 307-2), for which reference receivers only start appearing now. DVB-S2X stands for Digital Video Broadcast Second Generation Satellite Extension. Some problems experienced with precoding waveforms processed by those reference receivers are discussed hereinafter.

In the more recent prior art of satellite precoding, such as ETSI TR 102 376-2 V1.2.1 section C.5.2.4.2.4, WO2020/021001, WO2019/193085, U.S. Ser. No. 10/270,520 and WO2015/192995, the channel matrix coefficient estimation is performed on the forward link signal carrying data, using pilot symbols, which are then necessarily non-precoded (or not precoded, a synonym of non-precoded). Hence there is a need to either stick to the prior art concept of non-precoded pilots (and the drawbacks thereof discussed hereinafter), or provide for a means of channel matrix coefficient estimation different from the prior art.

To serve many terminals per physical carrier, some prior art solutions (see e.g. WO2015/192995, WO2019/193085 and the paper “Multicast Multigroup Precoding and User Scheduling for Frame-Based Satellite Communications”, Christopoulos et al., IEEE Trans. on Wireless Comm., Vol. 14, Issue 9, September 2015) apply a same precoding matrix not to a single terminal but to a cluster of terminals at different locations receiving that precoded carrier. This is called multicast precoding. Multiple clusters can then be served one after the other by the same carrier. Thus, a different precoding matrix (one per cluster) is applied to the same carrier, e.g., one precoding matrix per frame. Apart from an obviously complex optimal scheduling (clustering) challenge, most aspects of unicast precoding carry over to multicast precoding (in particular, how a terminal estimates the coefficients of the channel matrix H and how a precoding matrix is applied in the transmitter). However, multicast precoding suffers from a throughput performance loss growing with the cluster size and the corresponding compromising over larger sets of channel states. Hence, there is a need to improve the throughput compared to the multicast precoding solutions when serving multiple terminals per carrier. In addition, a terminal receiver in one particular cluster that demodulates a frame precoded for that cluster, followed by a frame precoded for another cluster, will see a significant SNR variation, as the first frame was precoded for that particular cluster (thus the interference was reduced and SNR increased) while the following frame was precoded for another cluster (thus the interference was not as much reduced, thus the SNR was not as much increased). These significant link quality variations cause huge problems for those receivers, e.g., for an adaptive coding and modulation (ACM) operation. The prior art is completely silent on how to solve this. There is thus a need for a solution to serve more than one terminal per carrier without causing significant link quality variations seen by the one or more terminal receiver demodulators.

In ETSI EN 302 307-2 (DVB-S2X) and ETSI TR 102 376-2 (guidelines DVB-S2X) the concept of superframes (SF) is introduced, coming in different superframe formats (SFF) targeted to different applications, but with overarching principles and signalling elements for receiver addressing and synchronization. The SF in those standards transport variable length physical layer frames as defined originally in ETSI EN 302 307. This means strings of symbols (Physical Layer Frames or PLFrames) are obtained after mapping coded bits from one codeword (64800 or 16200 coded bits obtained after encoding a so-called baseband frame of information bits) to data symbols multiplexed with known symbols and a short preamble (including known symbols and signalling) denoted a PLHeader.

The superframes in ETSI EN 302 307-2 and ETSI TR 102 376-2 have a start-of-superframe (SOSF) field, which is used in the terminal receiver to detect the start of a superframe. They can have superframe pilots (SF-Pilots) which the receiver uses for carrier tracking, i.e., for the recovery of the reference phase (and possibly reference level) for demapping and decoding of terminal data symbols.

In ETSI EN 302 307-2 V1.2.1 and ETSI TR 102 376-2 V1.2.1 SFF, the SFF2 and SFF3 formats organize whole physical layer frames in aligned groups called bundles. As mentioned in the guidelines, they explicitly target multicast precoding. With respect to SFF5, it is noted that it allows for fragmentation of a physical layer frame over different superframes. SFF5, according to the standard and the guidelines, explicitly targets beam hopping (BH) applications where constraints on the superframe length may arise. The physical layer frame is then split in at least two fragments of a physical layer frame, each in a different superframe. Allowing the fragmentation of a PLFrame over more than one superframe avoids the need for padding when requiring a particular superframe length to be obtained, thus decreasing the overhead.

Prior art disclosures like the above-mentioned standards or patents and applications like WO2020/021001, WO2019/193085, U.S. Ser. No. 10/270,520 and WO2015/192995 face some issues when the additional task of estimation of the coefficients of the above-mentioned channel matrix H is assigned to SF-pilots which are also used for carrier reference tracking. For performing the channel estimation task, as stated explicitly in the cited documents, the SF-pilots are not precoded, or, equivalently stated, the precoding matrix is set to an identity matrix for SF-Pilot symbols.

The effective channel for the precoded symbols is represented by the product H.W while the effective channel for the non-precoded symbols (like the SF-Pilots in the prior art) is H. Simply put, the SNR seen by the receiver for a channel H is typically much worse than for the precoded channel H.W. Also the gain and phase of the channel H seen by a receiver is typically different than for the precoded channel H.W. Consequently, the carrier tracking reference extracted from SF-Pilots is in general suboptimal for demapping and decoding of terminal data symbols, entailing a performance loss depending on several factors, for example on the accuracy of the channel state information. In addition, the difference in gain and phase for precoded and non-precoded symbols will confuse synchronization and equalization. The confusion of the synchronization, equalization and carrier tracking leads to a performance degradation, e.g. a reduced effective SNR and large SNR variations (which then again result in much margin in ACM, then again resulting in performance degradation). Without the presence of additive white Gaussian noise, a reference receiver with a precoding waveform was tested over a well-conditioned channel with interference. The effective SNR monitored on the prior art precoding waveform was only 10 dB, while one would expect that the precoding would boost the SNR above 25 dB. There is thus need for a precoding waveform or method where the useful data demodulation is not degraded by confusion from synchronization, equalization and carrier tracking of a receiver demodulator.

In satellite precoding it is necessary to account and compensate for differential frequency offset and differential time offset between precoded carriers. As elaborated in ETSI TR 102 376-2 V1.2.1 the phase of estimated channel matrix coefficients drifts in the presence of a residual differential frequency offset between precoded carriers. Common-mode frequency offsets and time offsets are in general not a problem as they preserve symbol alignment and are removed by the receiver's timing and carrier estimation loops for the carrier of interest. Hence, only differential offsets need to be accounted and compensated for.

The range of frequency offsets between jointly precoded downlink carrier signals is set by
differential uplink Doppler effect, which is always present in co-polar uplinks (as typically different uplink frequencies are used in the uplink from the gateway to the satellite, the so-called feeder link, which may give rise to different Doppler effects)
satellite and gateway reference oscillator offsets
the accuracy of any Doppler prediction pre-compensated in the gateway
   The initial uncertainty on differential frequency for immediately adjacent co-polar gateway uplinks may amount to ±2.5 ppm of the symbol rate in case of a GEO satellite and to ±10 ppm of the symbol rate for a MEO satellite (in the absence of pre-compensation of predicted MEO Doppler). For a 200 Msps forward link this means that when in a co-polar gateway frequency plan an interfering carrier was uplinked immediately next to the carrier of interest, the interfering carrier can at the terminal be received initially with up to 2 kHz offset from the carrier of interest, for the MEO case. These effects have not been prominent in reported satellite precoding field tests that were mostly conducted over GEO satellites, at lower symbol rates, and with cross-polar uplinks at almost identical RF frequencies. There is therefore an interest in providing for a measurement of differential frequency offset between beams in the terminals.

In ETSI EN 302 307-2 V1.2.1 and ETSI TR 102 376-2 V1.2.1 the SOSF and SF-aligned pilot fields are taken from a set of near-orthogonal symbol sequences, known as Walsh-Hadamard (WH) codes optionally plus some padding. There are 256 possible quasi-orthogonal SOSF fields, determined by an SOSF-index (corresponding to a row in a 256-by-256 WH matrix). The SF-aligned pilot fields are added on a per superframe level (aligned per superframe). Under aligned superframes across interfering carriers, the SF-aligned pilots are then also aligned across interfering carriers. In precoding, the near-orthogonality helps to preserve the performance in the tasks assigned to these fields in the presence of interference. Therefore, the prior art requires the reference scrambling index (which is scrambling the SOSF and SF-aligned pilots) to be identical across interfering carriers, exactly to preserve near-orthogonality of the SF-aligned pilots. In fact, the two-way scrambling, introduced with the introduction of superframes to DVB-S2X, was partly introduced for that reason. To have near-orthogonality of the scrambled SOSF field, recalling that the reference scrambling index is the same across interfering carriers, the prior art imposes different SOSF indices to be chosen for each of the interfering carriers. Unfortunately, the near-orthogonality of the scrambled SOSF and SF-pilot fields is only realized once the differential time offset between the fields among beams has been reduced to, for example, 10% of the symbol duration or less at the receiver input.

In “Exploiting orthogonality in DVB-S2X through timing pre-compensation” (S. Andrenacci et al., 2016 8th Advanced Satellite Multimedia Systems Conference and the 14th Signal Processing for Space Communications Workshop) the performance loss due to differential time offset is analysed, and a pre-compensation in the gateway is proposed as that is much more effective than performing corrections in the receiver (i.e. after the harm is largely done). In the above article, it is estimated that initial differential time offsets may amount to +/−3 symbols for 500 Msps (or Mbaud) carriers. In that case the orthogonality between different SOSF symbol sequences or between different SF-pilot sequences is way beyond 10% of the symbol duration and thus completely lost. For estimating time offsets in the terminal, the authors propose an early-late-gate technique that does not support a multi-symbol range, meaning that initial adjustment for high data rates cannot be obtained from the terminal and must be resolved by other methods, such as pre-calibrating differential delays in the gateway and satellite signal paths. The proposed early-late-gate technique also implies that in the receiver two complex samples per symbol are generated at least for some fields. This implies considerable complexity in the timing adjustment. A non-precoded signature field containing SOSF and superframe pilots is applied. The SuperFrame Format Indicator (SFFI) is not a part of the signature field and is precoded.

However, ASIC and FPGA implementations for the ETSI EN 302 307-2 V1.2.1 standard, especially low power and or low-cost implementations, typically reduce sampling to one sample per symbol as soon as possible, in order to limit processing clock rates or signal bus widths. Hence, solutions operating at two samples per symbol may be hard to add-on efficiently (with low area and power and with low design effort) to a legacy receiver for that standard. There is thus a need for an improved precoding waveform and method for differential time offset estimation up to +/−3 symbols, ideally also working with only one sample per symbol to afford implementation in affordable receivers.

Finally, the prior art presents a precoding waveform for which receivers can perform channel estimation on whichever frame they prefer. It is typically too complex to perform channel estimation on every frame. In addition, this would result in unnecessary high overhead in the link from the terminal to the hub to feedback those channel estimations. Therefore, the receivers in the prior art solutions often select (without orchestration from the gateway) a subset of frames to do channel estimation for. This, however, has some disadvantages. For instance, when the terminal estimates a frequency offset, this frequency offset estimation may be erroneous when the transmitter performed a frequency correction in the symbol span used by the receiver for the estimation. Secondly, in a multi-terminal per carrier (MTPC) scenario, multiple precoding matrices may be applied on the same carrier, sequentially in time. The channel estimation accuracy depends on the precoding matrix that has been applied so it is not desired that a receiver does the channel estimation on a frame it chooses by itself. Finally, a gateway can more reliably combine channel estimations from multiple terminals when those channel estimations have been performed at the same time. There is thus a need for another solution than those of the prior art where terminals themselves choose a subset of frames to perform channel estimation for.

Hence, there is a need for a solution where one or more of the drawbacks and limitations of the prior art solutions are overcome.

### SUMMARY OF THE INVENTION

It is an object of embodiments of the present invention to provide for a transmitter arranged to generate digital signals having a waveform that allows for improved differential time offset estimation.

The above objective is accomplished by the solution according to the present invention.

In a first aspect the invention relates to a transmitter for generating for each of at least two physical carriers a digital signal for estimating differential time offset between the at least two physical carriers. The transmitter comprises modulation means for processing for each of the physical carriers a stream of symbols arranged in a set of superframes as defined in the DVB-S2X standard. The superframes each comprise at least an amount of known symbols and at least one physical layer frame or physical layer frame fragment, said known symbols comprising a Start-of-SuperFrame (SOSF) field defined by a superframe specific SOSF index and a SuperFrame Format Indicator (SFFI) field. The modulation means is arranged for performing a superframe specific scrambling of at least the SOSF field with a reference scrambler, the scrambling sequence being used to scramble the SOSF field being identified by a reference scrambling index, and for performing a superframe specific scrambling of at least the SFFI field with a payload scrambler, said scrambled SFFI field identified by a payload scrambling index. For each of the at least two physical carriers at least a subset of the set of superframes is arranged for estimating a difference in time offset between the at least two physical carriers. Those superframes of the subset are denoted estimation frames. The transmitter further comprises time alignment-means to time align the at least two physical carriers. The estimation frames are time-aligned across the at least two time aligned physical carriers so that channel estimation can be performed. The payload scrambling indices are different across the at least two physical carriers for the time-aligned estimation frames. Each of the estimation frames comprises a non-precoded signature field, said signature field comprising at least a part of the scrambled SOSF field and at least a part of the scrambled SFFI field. For each of the physical carriers the digital signal comprises the set of superframes processed in the modulation means.

The proposed solution indeed allows for obtaining digital signals which are better suited for time offset estimation. In this aspect of the invention this is achieved by modifying the signature field compared to, for example, the signature used in the above-mentioned paper of Andrenacci. The superframes comprise a number of known symbols and at least one physical layer frame. It is thereby not required to have an integer number of physical layer frames in a superframe. The known symbols in the superframes comprise a SOSF field defined by a superframe specific SOSF index and a SFFI field. The SOSF field is identified by a SOSF index that is specific for the superframe the SOSF field is part of. So, each superframe of the set of superframes has its own SOSF field with corresponding distinguishing SOSF index. Multiple superframes may have an SOSF field configured with the same SOSF index. The modulation means performs by means of a reference scrambler a scrambling of at least the SOSF field specific for the superframe. The scrambled SOSF field is identified by a reference scrambling index specific for the (scrambled) SOSF field of the corresponding superframe. For at least the SFFI field scrambling is performed with a payload scrambler and the scrambled SFFI field is characterised by a payload scrambling index which is again specific for the superframe the SFFI field belongs to. The payload scrambling indices are different across the time-aligned at least two physical carriers for the estimation frames. In this invention a signature field is defined as follows: each estimation frame comprises a non-precoded signature field, whereby said signature field comprises at least a part of the scrambled SOSF field and at least a part of the scrambled SFFI field. It is however not needed that in frames not being used as estimation frames the complete signature field is precoded, it is sufficient that big chunks of the signature (comprising at least a part of the scrambled SOSF field and at least a part of the scrambled SFFI field) are precoded. The signature field as defined in this invention is clearly different from the signature field in the above-mentioned paper by Andrenacci.

In a preferred embodiment the transmitter comprises precoding means configured for precoding symbols comprised in the set of superframes, said symbols not belonging to the signature field. The symbols may be unknown symbols or known symbols like e.g. pilot symbols.

Preferably the SFFI fields of the time-aligned estimation frames across the at least two physical carriers are scrambled with near-orthogonal patterns taken from a set of predetermined near-orthogonal patterns. This set of predetermined near-orthogonal patterns is a subset of the scrambling patterns available in DVB-S2X.

In advantageous embodiments the transmitter is arranged for adding a superframe count to designate which frames are estimation frames. In other advantageous embodiments the transmitter is arranged for designating which frames are estimation frames by means of said reference scrambled SOSF field. In some embodiments the transmitter is configured for applying either of the two above-mentioned designation methods.

In a preferred embodiment the time alignment means comprises a numerically controlled oscillator to time-align the estimation frames across the at least two physical carriers.

In some embodiments all superframes of the set are time-aligned across the at least two physical carriers.

In one embodiment superframes precoded with a different precoding matrix have at least one of a SOSF-ID or the reference scrambling index different.

In embodiments the transmitter is arranged for receiving an updated configuration based on feedback from one or more terminal receivers on the differential time offset ehannel-estimation.

In one embodiment the transmitter is arranged to adjust time-alignment between the estimation frames across the at least two physical carriers based on the estimated difference in time offset.

Advantageously, the precoding means in the transmitter can be configured based on the feedback.

In a preferred embodiment at least one superframe not being an estimation frame has a precoded signature field.

In some embodiments the reference scrambling indices are the same across the at least two physical carriers for the time-aligned estimation frames.

In one embodiment the SOSF indices—are different across the at least two physical carriers for the time-aligned estimation frames.

In another embodiment the known symbols comprise at least one pilot field for carrier tracking.

In one embodiment at least one estimation frame comprises at least one physical layer frame obtained from a baseband frame with dummy data bits or being a dummy physical layer frame as specified in DVB-S2X.

In an aspect the invention relates to a satellite communication system comprising a transmitter as previously described and at least one set of one or more receivers.

Preferably at least one of the receivers is arranged to add superframe count information to the feedback. In some embodiments the superframe count information is derived from a superframe header field.

In some embodiments the communication system is arranged for changing at least one of a SOSF-ID or the reference scrambling index of a superframe for another set of receivers than a preceding superframe and for updating a precoding matrix based on channel information from the other set of one or more receivers. Note that the updated precoding matrix may in some cases be an identity matrix, which obviously corresponds to applying no precoding at all to fields of the superframe.

Advantageously the preceding superframe comprises a postamble to indicate that serving of the other set of receivers with the updated precoding matrix is about to start.

In another aspect the invention relates to a transmitter for generating for each of at least two physical carriers a digital signal for estimating channel information related to the at least two physical carriers. The transmitter comprises precoding means and modulation means arranged for processing for each of the physical carriers a stream of symbols arranged in a set of superframes as defined in the DVB-S2X standard. The superframes each comprise at least a number of known symbols and one or more physical layer frames or physical layer frame fragments, said known symbols comprising a SOSF field defined by a superframe specific SOSF index. The modulation means are arranged for performing a superframe specific scrambling of at least the SOSF field with a reference scrambler, the scrambling sequence being used to scramble at least said SOSF field being identified by a reference scrambling index. At least a subset of the set of superframes is arranged for performing channel estimation. The superframes of the subset are denoted estimation frames. The estimation frames are time-aligned across the at least two physical carriers. The reference scrambling indices are the same across the at least two physical carriers for the time-aligned estimation frames, whereas the SOSF indices are different across the at least two physical carriers for the time-aligned estimation frames. Each of the estimation frames comprises a signature field, whereby the signature field comprises at least a part of the scrambled SOSF field. At least one superframe not being an estimation frame has a signature field precoded with the precoding means and for each of the physical carriers the digital signal comprises the set of superframes processed in the modulation means.

According to the invention a distinction is made between superframes for performing differential time offset estimation and, optionally, channel coefficient estimation and superframes which are not used for time offset and, optionally, channel coefficient estimation, i.e. non-estimation frames. Again the superframes do not necessarily have to contain an integer number of physical layer frames. The superframes each comprise known symbols with a SOSF field defined by a SOSF index specific for the superframe the SOSF field belongs to. The modulation means are arranged for performing a superframe specific scrambling of at least the SOSF field with a reference scrambler, said scrambled SOSF field being identified by a reference scrambling index. The reference scrambling indices are the same across the at least two physical carriers for the time-aligned estimation frames. The SOSF indices are different across the at least two physical carriers for the time-aligned estimation frames. Each estimation frame comprises a signature field which contains at least a part of the scrambled SOSF field. At least one superframe being a non-estimation frame has a signature field precoded with the precoding means. The signature field may be a signature field as known in the prior art or a longer signature field as set out above.

In a preferred embodiment the reference scrambling indices for frames not being estimation frames, i.e. for non-estimation frames, are different across the various physical carriers.

In preferred embodiments the known symbols in the superframes also comprise a SFFI field. The modulation means may then be arranged for performing a superframe specific scrambling of at least the SFFI field with a payload scrambler, the scrambling sequence being used to scramble the SFFI field being identified by a payload scrambling index, and the signature field also comprises at least a part of the scrambled SFFI field. The SFFI fields are advantageously scrambled with near-orthogonal patterns taken from a set of predetermined near-orthogonal patterns.

In some embodiments all superframes of the set are time-aligned across the at least two physical carriers.

In embodiments of the invention the transmitter is arranged for receiving an updated configuration based on feedback from one or more terminal receivers on the channel estimation. The transmitter may further be arranged to configure the precoding means based on the feedback.

In preferred embodiments the known symbols comprise at least one pilot field for carrier tracking.

In an aspect the invention relates to a satellite communication system comprising a transmitter as previously described and at least one receiver.

In one embodiment at least one of the receivers is arranged to add superframe count information to the feedback.

The superframe count information is in some embodiments derived from a superframe header field.

Preferably the satellite communication system is arranged for changing at least of a SOSF-ID or the reference scrambling index of a superframe for another set of receivers than a preceding superframe and for updating a precoding matrix based on channel information from the other set of one or more receivers.

The preceding superframe comprises a postamble to indicate that serving of said other set of receivers with said updated precoding matrix is about to start.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, wherein like reference numerals refer to like elements in the various figures.

FIG. 1 illustrates a high-level block diagram of a transmitter according to the invention.

FIG. 2 illustrates a time aligned superframe and shows that PLFrames within the superframe are not per se time aligned.

FIG. 3 illustrates a high-level block diagram of the forward link data path in a satellite communications system where transmitters as in the invention reside in an earth station gateway.

FIG. 4 illustrates a precoded forward link with a centralized gateway.

FIG. 5 illustrates a high-level block diagram of the forward link data path in a satellite communications system where transmitters of the invention reside in a regenerative satellite.

FIG. 6 illustrates the split of frames into estimation frames and non-estimation frames.

FIG. 7 illustrates an arrangement of frames in jointly precoded interfering carriers, showing nominally aligned signature and pilot fields in estimation frames, and further also showing pilot fields in non-estimation frames.

FIG. 8 illustrates a transmitter for two time-aligned carriers with differential time pre-compensation capability according to the invention.

FIG. 9 illustrates a modified stored impulse response pulse shaping filter realizing configurable smooth time alignment for a carrier, according to the invention.

FIG. 10 illustrates a superframe structure according to DVB-S2X superframe format 5 indicating choices for precoding of superframe fields and scrambling, according to the invention.

FIG. 11 illustrates a terminal adapted for realizing the forward link linear precoding according to the invention.

FIG. 12 illustrates a method for differential path delay estimation in the terminals and closed loop timing pre-compensation.

FIG. 13 illustrates a method for channel matrix coefficient estimation in the terminals and closed loop precoding.

FIG. 14 illustrates a means to provide for a superframe count, according to the invention.

FIG. 15 illustrates a method for estimating the frequency offset between a carrier of interest for a terminal receiver and at least one interfering carrier for that receiver and closed loop frequency pre-compensation.

FIG. 16 to 21 illustrate flow charts representative of methods elucidated in this description.

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

Some definitions of terms employed in this description are first given.

A hub is a gateway between the access network of terminals, for example a satellite access network, and the core network (also known as the Internet). The hub side of the access network is typically more expensive with better equipment, such as more expensive power amplifiers having sufficient power to be operative in the linear region (resulting in less non-linear distortion) and better link quality with the satellite. The gateway may possibly be a distributed entity. The gateway terminates links to or from the terminals in the access network and typically also connects to a terrestrial data transport network; in a traditional bent-pipe satellite communications system the gateway is located entirely in the ground segment; in a regenerative satellite communications system the termination of satellite links to the terminals is devolved to a gateway proxy on-board a satellite and separate feeder links and possibly inter-orbit links (not discussed in this description) relay data between the gateway proxy and terrestrial data networks. The Network Control Centre (NCC) functions of generating forward link signalling and processing return link signalling are considered as part of the gateway (or gateway proxy), even if not represented on diagrams with focus on the forward link data path.

A terminal is the remote end of the satellite or wireless access network that optionally aggregates a small amount of user equipment, e.g., computers and smart phones.

A communication link is to be construed as a wireless link with a feedback channel. Typically, both the wireless link and the feedback channel are wireless. The links are “over satellite”, meaning that the satellite is part of the link between transmitter and receiver. A digital satellite communication system is considered comprising at least one transmitter and at least one receiver.

The term ‘communication network’ refers to all components combined, being hub(s), terminal(s), communication link(s) and computers with the Internet. In some embodiments the communication network is a star network, whereas in other embodiments point-to-point connections are encountered.

In this invention a satellite communication system is considered. In general, communication then occurs via a link over satellite, called the forward (FWD) link, from a hub (also named gateway) to a terminal receiver or, as in some embodiments of the present invention, to multiple terminal receivers, and a link called the return (RTN) link from the terminal(s) to the hub, so that interactive communication is possible. In the case of multiple terminals per hub, this network is referred to as a star network. A hub or gateway communicates with a terminal via at least one satellite. In such a system, multiple terminals may be covered through a single hub. A satellite communication service may contain several hubs. A hub may contain several transmitters and/or receivers, e.g., if the bandwidth needed in the forward link is larger than the bandwidth that can be transmitted from a single transmitter.

In the modulator each information frame is encoded by a forward error corrected (FEC) frame (called coding), mapped to a physical layer frame of symbols (called modulation) and pulse shaped to a baseband waveform. In DVB-S2(X), said information frame is denoted a baseband frame. Hence, each baseband frame is associated to a modulation and coding (modcod). This baseband waveform is finally upconverted onto a carrier frequency by an IQ modulator.

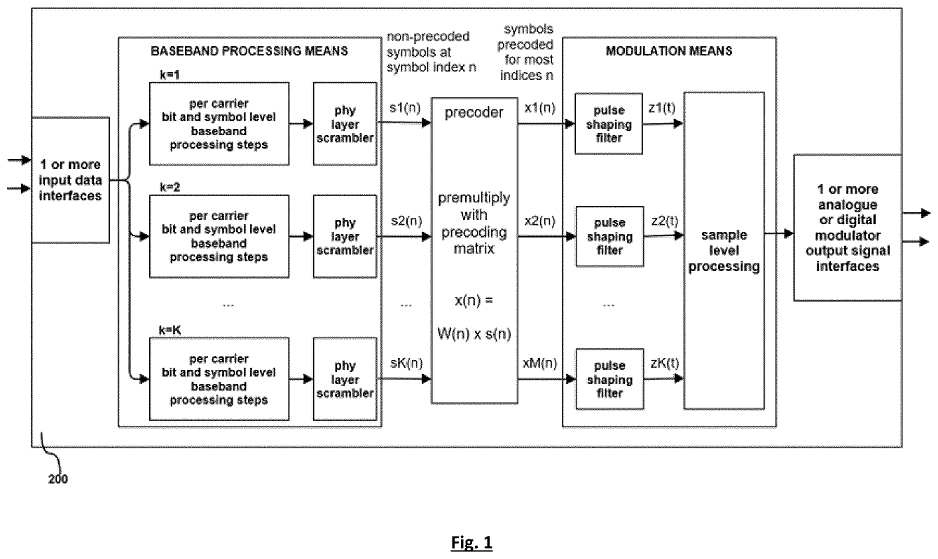

FIG. 1 illustrates a transmitter configured for transmitting via K digital communications carriers that are jointly linearly precoded (meaning that K parallel symbols are transformed by a K-by-K matrix) at symbol level (so before the pulse shaping filter). Precoding and pulse-shaping are both linear operations, so their order is interchangeable and the invention is not limited to applying precoding before the pulse shaping filter. In FIG. 1 non-precoded symbols are processed by setting the precoding matrix to an identity matrix, which obviously corresponds to applying no precoding at all to certain symbols in the superframe. For each carrier, an information data stream is mapped first to a non-precoded symbol stream by applying the following baseband processing steps: encapsulation, baseband header insertion, baseband scrambling, error correction encoding, bit mapping to complex-valued points of a transmit constellation, physical layer header insertion, physical layer scrambling. All these steps are as such well known in the art and do not require further explanation. A transmitter may of course comprise more than one device. E.g., a device performing encapsulation, and another device doing baseband header insertion, baseband scrambling, error correction encoding, bit mapping to complex-valued points of a transmit constellation, physical layer header insertion, physical layer scrambling. The invention is not limited to a particular number of transmitters performing a transmitter operation and to which functions are performed in which device of the transmitter.

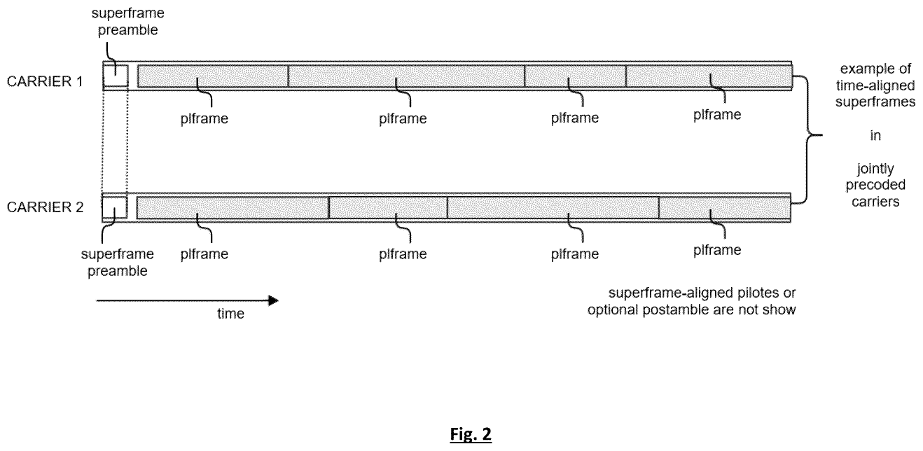

It was already mentioned that in ETSI EN 302 307-2, the notion of superframes (SF) was added. This came with some changes.
(1) In superframes, the already mentioned PLFrames are slightly modified. The PLHeader is roughly “extended” (4 versions, each with a different PLHeader length) to accommodate different protection levels (from robust to efficient: very robust, robust, standard, high efficiency) allowing decoding the PLHeader at lower signal to noise ratios for a higher protection level. The normal PLFrame pilot symbols are not present anymore in SF mode (except for VLSNR pilots in the case of protection levels robust and very robust). The per PLFrame physical layer scrambling is not present anymore and organized on a superframe level, denoted two-way scrambling. In two-way scrambling, the SOSF and SF-aligned pilot symbols are scrambled with the reference data scrambler and all other symbols are scrambled with the payload data scrambler.
(2) Further, a preamble (and optionally a postamble) and SF-aligned pilots were added so that a superframe can be seen as a container of PLFrames. More specifically, the preamble contains a start-of-superframe (SOSF), a superframe format indicator (SFFI), and optionally other elements (such as a superframe header (SFH) in format 5, or an Extended Header Field (EHF) and protection level indicator (PLI) in format 6. The superframe preamble contains a big “known” part (although depending on configuration), e.g., for acquisition. In an embodiment of this invention the known part can be used to indicate whether a superframe should be demodulated or not. This can be beneficial to avoid confusing the synchronization or equalization state machines in certain scenarios described further in this disclosure. In format 5, the superframe preamble further contains a few encoded parts to signal variables, more specifically to signal the PLI (e.g., to change the protection level on a per-superframe basis) and to signal two user bits.
(3) While the PLFrames are variable in length (depending on the modcod), superframes can be made constant in length which allows “time-aligning” superframes across carriers with the same symbol rate, as visualized in FIG. 2. The implementation guidelines ETSI TR 102 376-2 describe this as a means to perform channel estimation for precoding. In an embodiment of this invention superframes are time-aligned, which automatically entails, by the property of superframes, that the preamble and the SF-aligned pilots are time aligned. Note that the invention merely uses this time-alignment of known symbols (although depending on configuration). It is not required that those known symbols are part of the preamble. Also, a midamble, postamble or actually any block of known symbols inside a frame structure would suffice.
(4) New VLSNR modcods were introduced allowing communication down to (depending on the implementation) −10 dB roughly.
(5) Finally, in format 5, a PLFrame may be fragmented, meaning that the superframe may “end” and a new superframe may “start” (coming with a superframe preamble) while the last PLFrame in the “ending” superframe was not fully included yet. The remaining part of the PLFrame is then included in the “new” superframe. In theory a PLFrame can be included in more than two superframes.

Per symbol interval with index n, one symbol sₖ(n), k=1 . . . K is delivered in each of the K transmit chains (1 chain per carrier). Symbol level linear precoding consists in processing the symbol sₖ(n) to the symbol xₖ(n), where

$${x}_{k} ( n ) = {\sum }_{m = 1}^{K} {W}_{k m} ( n ) \times {s}_{k} ( n )$$

and the Wₖₘ(n) represent the complex valued elements of a K×K channel precoding matrix W(n) that pre-multiplies the K×1 vector s(n) for symbol index n. For each k, the sequence xₖ(n) is then fed to a pulse shaping filter. In preferred embodiments the pulse shaping filters (see also FIG. 1) have a same group delay. Optionally, for some symbol indices n, one may set xₖ(n)=sₖ(n) or equivalently W(n)=I_{K}. If this is the case for a range of consecutive symbol indices n, n+1, . . . n+L−1, the corresponding field of length L can be said to be not precoded or non-precoded. The complex baseband output signal of the k^{th} pulse shaping filter is denoted as zₖ(t), where t is a time index. After the pulse shaping filters further sample level processing steps may be applied before delivering the resulting samples to a digital IF output interface or a digital-to-analogue convertor. As shown in FIG. 1, the pulse shaping filters and the sample level processing means together constitute the modulation means. Examples of such sample level processing steps are: a) combining; the baseband signals zₖ(t) are digitally frequency shifted, summed, and converted to the analogue domain; b) linear pre-distortion filtering is applied to the baseband signals zₖ(t) or to the sum signal in order to combat linear distortion affecting the analogue signal transport in the gateway, gateway antenna system, or uplink signal path; c) the digital frequency shift of signals zₖ(t) is fine-tuned to combat Doppler frequency offsets or reference oscillator offsets; d) the signals zₖ(t) or the sum signal is delayed using an interpolation filter in order to combat path delay differences; d) the signals zₖ(t) or the sum signal is nonlinearly pre-distorted in order to combat non-linear distortion affecting the analogue signal transport in the gateway. In precoded systems, the jointly precoded K carriers use the same downlink spectrum resource in the K distinct but partially overlapping beams.

In one aspect the present invention discloses a transmitter configured for communication with at least two receiver devices over a satellite communication system via at least two physical carriers. One of the physical carriers is the carrier of interest that carries information to the considered terminal receiver. The one or more other carriers carrying information for one or more other terminal receivers are referred to as interfering physical carriers. To reduce interference from other physical carriers the transmitter comprises precoder means arranged to perform linear precoding as illustrated in FIG. 1.

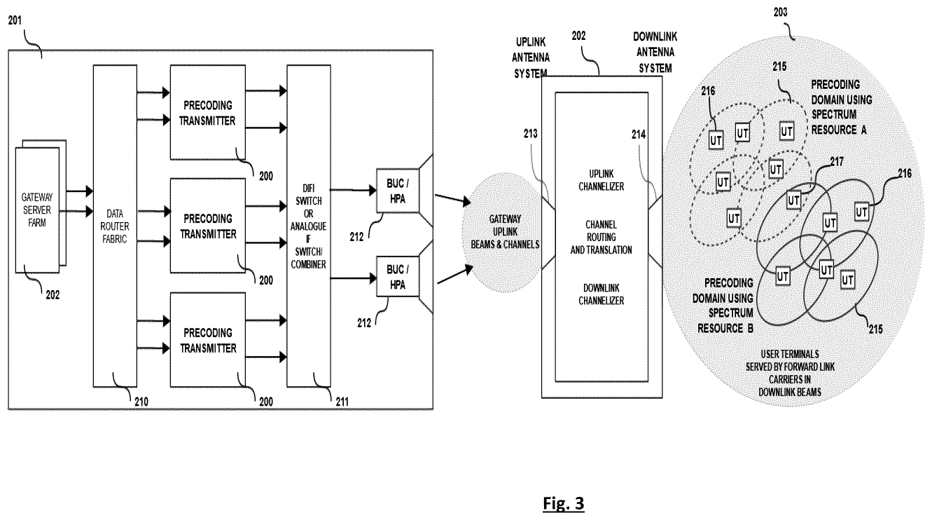

FIG. 3 illustrates an embodiment of a satellite communications system where one or more transmitters 200 according to the invention are part of an earth station gateway 201. FIG. 3 depicts only elements in the forward link data path. Other components than those depicted may be present in the gateway, for example return link elements and control plane elements in the forward or return link. In some embodiments, a gateway may support forward links without precoding in addition to forward links with precoding illustrated in FIG. 3, for example when serving satellite downlink beams that do not interfere with other beams. In some embodiments, illustrated in FIG. 3, the transmitters 200 accept input data relayed through gateway servers 202 and a data router fabric 210. The analogue or digital IF output signals from the transmitters are typically connected to one or more gateway block up-converters (BUCs) and High-Power Amplifiers (HPAs) 212. If a digital IF link is used, the BUC is typically referred to as a “digital” BUC. From the HPAs, the feeder link carriers are relayed to the satellite's uplink RX antenna system 213 via one or more gateway feeder link TX antennae. In the satellite, any set of K precoded carriers among the feeder link carriers is translated to a same downlink spectrum resource to exploit full frequency reuse among said set of K carriers. The precoding domain size K need not take the same value in every set of jointly precoded carriers delivered by transmitters 200. In some embodiments, illustrated in FIG. 3, that translation involves the line-up of a configurable uplink channelizer, channel router and downlink channelizer supporting frequency translation. Each of the K translated carriers is then connected to a different downlink beam provided by the satellite's downlink TX antenna system 214. In some embodiments, said line-up and antenna system 214 support configurable beamforming. As illustrated in FIG. 3, in some embodiments the service area 203 serving user terminals (UT) 215 may comprise precoding domains using a different downlink spectrum resource. With precoding domain is meant a set of jointly precoded carriers. By extension, a precoding domain may indicate the set of terminals receiving one of these jointly precoded carriers (as carrier of interest). Some terminals 217 may receive carriers belonging to the different precoding domains. Although not depicted in FIG. 3, it is understood that a service area 203 may be served by carriers precoded in transmitters residing in different gateways.

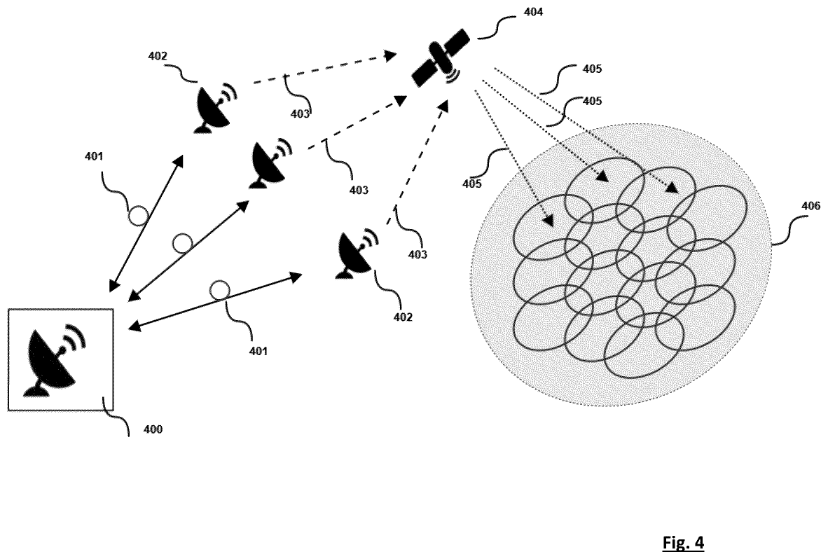

FIG. 4 illustrates a configuration of the forward link of satellite system where the jointly precoded carriers in at least one precoding domain are uplinked via geographically distributed RF feeder gateways 402. This is of interest for example when a large precoding domain 406 requires more feeder capacity than can be uplinked to the satellite 404 from a single gateway location in the available feeder spectrum. In the literature is mentioned that this can be handled by providing a centralized gateway 400, for example connected to the RF gateways 402 by optical links 401. The feeder links 403 for the large precoding domain emanate from the different RF feeder gateways 402 and are translated in the satellite 404 to forward downlink signals 405 sharing a frequency resource. It is obvious to a person skilled in the art of satellite communications that the transmission of jointly precoded carriers can also be realized in a centralized gateway 400. The transmitter is in that case situated in a centralized gateway.

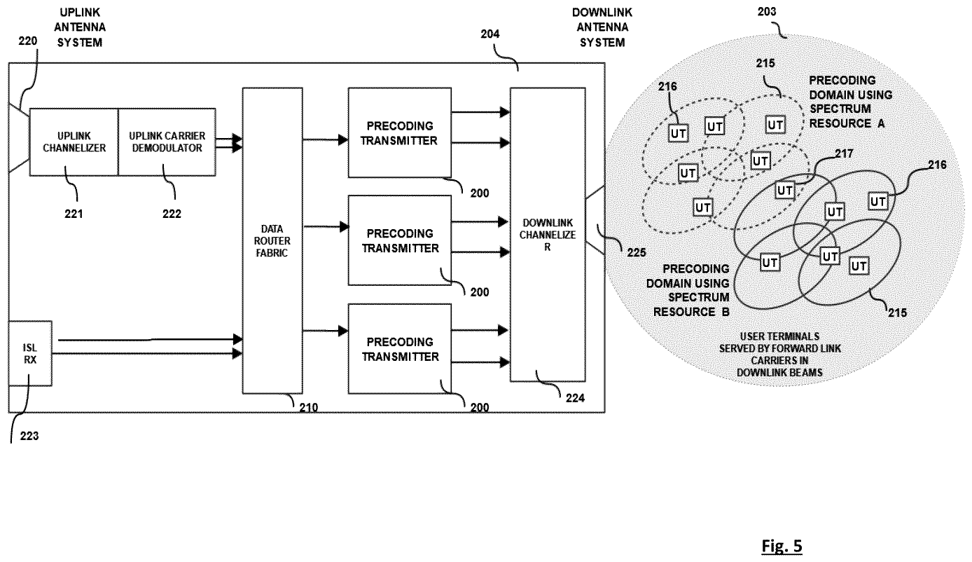

FIG. 5 illustrates an embodiment of a satellite communications system where the at least one transmitter 200 is part of the satellite 204 that transmits the downlink beams. The input data to a transmitter can be locally generated in the satellite 204 that transmits the downlink signals. Or, more commonly, the input data reach the satellite 204 by means of digitally modulated optical signals or radio frequency signals, either uplink signals to the satellite 204 from a ground station, or intersatellite link (ISL) signals transmitted to satellite 204 by another satellite, or both. For example, the uplink signals may be digitally modulated RF signals received by the uplink satellite antenna system 220, selected by an uplink channelizer 221 and demodulated by an uplink carrier demodulator 222. For example, the intersatellite link signals may be digitally modulated optical signals demodulated by an optical ISL receiver 223. The demodulated uplink signals or intersatellite link signals may be connected to the one or more transmitters through on-board data router fabric 210. The output signals of transmitted 200 are typically connected to a downlink antenna system 225 through a downlink channelizer 224. In the context of precoding the downlink antenna system 225 typically comprises beamforming.

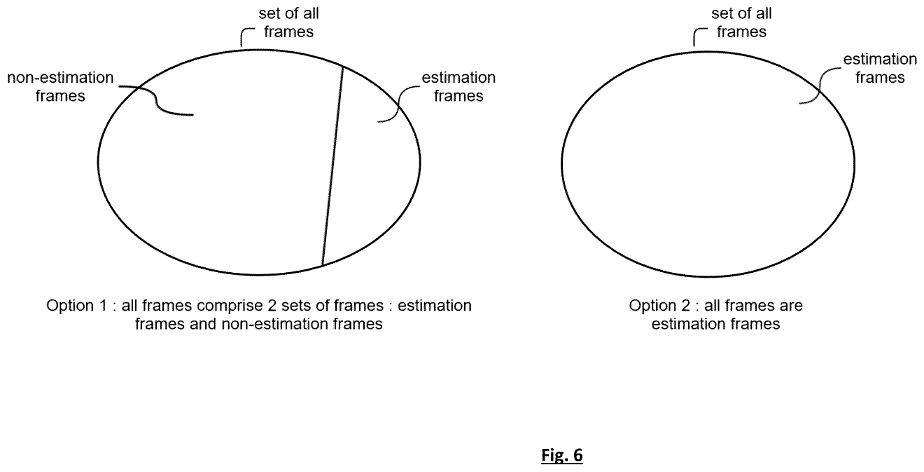

The modulation means in the transmitter yield as output for each carrier a set of frames to be transmitted. At least some of these frames contain fields that are time aligned with other carriers and that can be used for the estimation of channel coefficients and for differential frequency and time-offset estimation, briefly referred to as “channel estimation”. In preferred embodiments, these frames are superframes according to ETSI EN 302 307-2, but as mentioned above, any framing structure allowing for fields being time aligned with other carriers can be used. In some embodiments at least some of the frames are at a receive side used for estimating coefficients of the channel matrix H, which allows selecting or computing a precoding matrix W(n). These frames are in this description referred to as estimation frames. More in general, estimation frames are frames used for performing channel estimation. Later in this description some possible ways to designate frames as estimation frames are explained. In one embodiment, all receivers of a given physical carrier use the same estimation frames for channel estimation, but the invention is not limited thereto. In another embodiment, receivers in distinct beams use different estimation frames for channel estimation. In some embodiments all frames of the set of frames to be transmitted are such estimation frames. In such case there is no need for specifically indicating which frames are the estimation frames. However, in many embodiments it is not needed to perform an estimation for each frame. It is also to be noted that performing so many estimations, considerably increases the computational load. Therefore, in preferred embodiments not all frames are estimation frames. The frames not being estimation frames are simply referred to as non-estimation frames in this description. In preferred embodiments many frames are non-estimation frames. As a rule of thumb an estimation frame is needed about every 100 ms, but the optimal value depends on many factors and is typically in the range of 10 ms to 1000 ms, preferably in the range of 20 ms-750 ms, more preferably in the range of 40 ms-500 ms. Possibly relevant factors include the speed of variations in the interference channel that result from, for example, satellite and gateway oscillator drift, changing geometry of the satellite link, terminal mobility, changing satellite payload characteristics, . . . . In case all frames are estimation frames, there are no non-estimation frames. FIG. 6 provides an illustration: each frame of the set is either an estimation frame or a non-estimation frame. The right-hand part of the figure depicts an embodiment as mentioned above, wherein all frames are estimation frames.

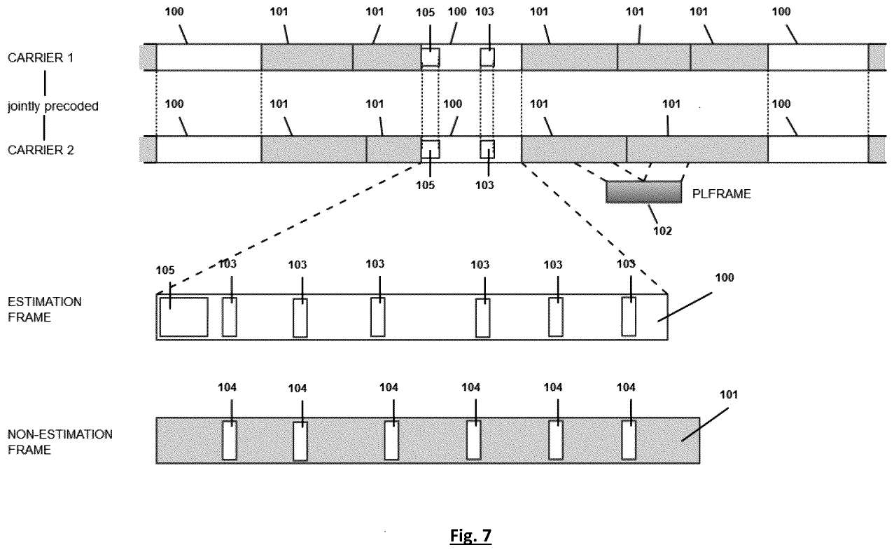

An example with two physical carriers (i.e., a carrier of interest for a certain terminal receiver and an interfering carrier for the considered receiver) is illustrated in FIG. 7, where an arrangement of frames is shown in jointly precoded interfering carriers of equal symbol rate. As can be seen from the figure, the estimation frames 100 are nominally time-aligned across the physical carriers. Non-estimation frames are not necessarily time-aligned among carriers. The example in FIG. 7 can be extended to K jointly precoded physical carriers of equal symbol rate, where K may be larger than two. In that case, estimation frames are nominally time-aligned in any subset of two carriers among said K carriers as per FIG. 7. Clearly, such two-by-two alignment implies that estimation frames are nominally time-aligned among the K jointly precoded physical carriers.

By “nominally aligned” is first meant that the fields or symbols indicated as time-aligned in FIG. 7 have an identical number of symbols in-between, irrespective of the physical carrier under consideration among the set of jointly precoded carriers. It is secondly meant that the transmit time difference of such nominally time-aligned symbols or fields in the transmitter is bounded to be within a few symbols. This implies that the long-term symbol rate in all K jointly precoded carriers is identical. As will be discussed later in more detail, advantageously, for K jointly precoded carriers, where K may be larger than two, the bounded transmit time differences of the nominally time-aligned fields in each of the K carriers are adjusted to achieve arrival time differences of the nominally time-aligned fields or symbols to be within 15% of a symbol period among a terminal's carrier of interest and the up to K−1 interfering carriers that are jointly precoded with the terminal's carrier of interest. The carrier of interest to a terminal is the carrier demodulated and decoded by the terminal.

The symbol rate is in practice configured in the transmitter by a numerically controlled oscillator (NCO). In its most common form, the NCO has a binary register, called the accumulator, that is incremented, in each clock cycle, modulo a positive integer N by a preconfigured integer value nR in the range 0<nR<N. When the updated accumulator value is smaller than the accumulator value in the previous clock cycle, a symbol valid event occurs, meaning that a symbol is added to the tapped delay line of a pulse shaping filter. The integer nR thus exactly represents the average symbol rate R as follows: R=(nR/N).(1/T) where T is clock cycle interval. Clearly, identical symbol rates are realized across pulse shaping filters for different carriers by sharing the NCO or equivalently, by using NCO circuits that share the update clock cycle and the integer values nR and N.

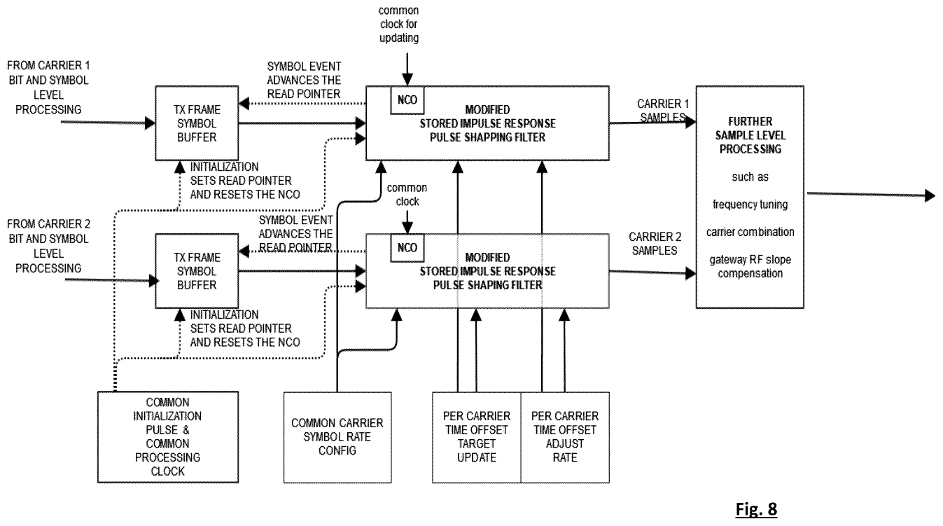

In this disclosure the above-mentioned prior art technique for delivering equal symbol rates in a transmitter is adapted to provide nominally time-alignment among carriers (per the definition given above for nominal time alignment) in line with the ETSI TR 102 376-2 and adapted also to ensure smooth updates of the transmit time differences. FIG. 8 illustrates a transmitter for two time-aligned carriers with smooth differential time pre-compensation capability according to the invention. Each pulse shaping filter takes symbols from the respective frame buffer holding the symbols to be transmitted in a time-aligned fashion. Each pulse shaping filter has an NCO connected to a common update clock. Hereafter the symbol events derived from the NCO are used to read a symbol from the frame buffer and increment the read pointer to the next symbol location in the buffer. The initialization comprises the following actions: (a) configure common symbol rate values; (b) configure the initial read pointer for each frame buffer to a first symbol that is nominally time aligned across carriers; (c) reset the NCO logic in the pulse shaping filters to accumulator value 0; and, advantageously, (d) configure the per carrier time adjust rate to 0. By virtue of this procedure and the definition of time alignment, time aligned symbols are transmitted in lock-step across the carriers (essentially 0 differential time offset at the transmitter of aligned features).

If the detailed modified pulse shaping filter of FIG. 8 is used, each carrier's time lead/lag with the respect to the initial situation (no lead/lag) becomes configurable and approaches the configurable target time offset value with a configurable adjustment rate. For the detailed discussion by way of example the convention is adopted that a positive time offset corresponds to a time lead in the carrier.

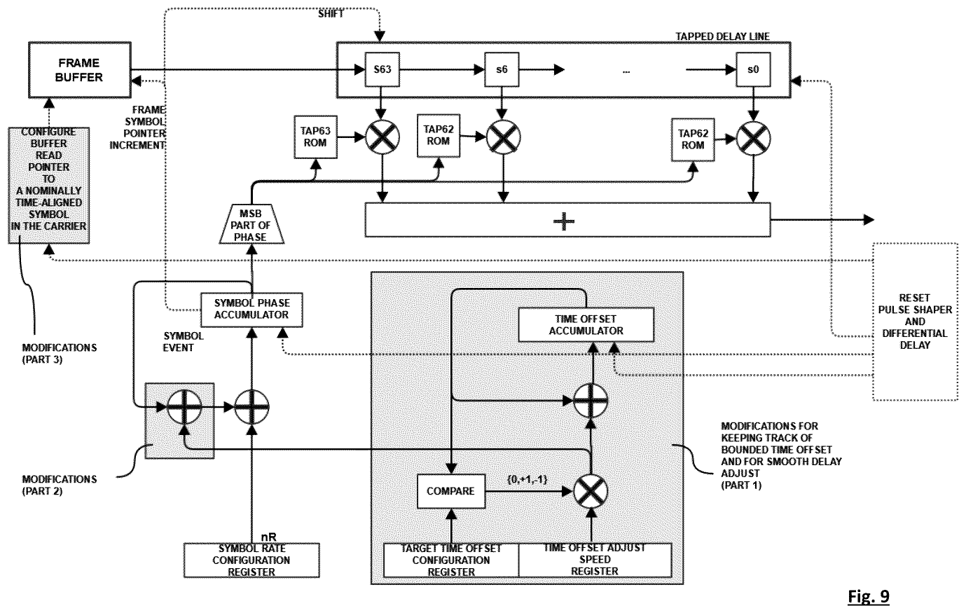

FIG. 8 illustrates a modified pulse shaping filter and NCO adapted for realizing efficiently a configurable relative transmit delay among carriers. The technique is illustrated for a stored impulse response type of pulse shaping filter. To explain the operation more clearly, by way of example the convention is adopted that a positive time offset corresponds to a time lead in the carrier. The modifications (part1, part2, part3) are illustrated in the shaded boxes in FIG. 9. The NCO accumulator earlier discussed is modified (modification part2) to allow for addition, in each clock cycle, of a term modifying the configured symbol rate by a small amount. The sub-circuit (modification part1) tracks the time offset built up by exactly integrating the symbol rate modification to represent the time offset. This value is compared with the target time offset value in the configuration register. When the tracked time offset value reaches the configured target value, further symbol rate modifications are nullified (are multiplied by 0). When the tracked time offset value is higher than the configured target value (too much lead), further symbol rate modifications are applied with negative sign (multiplied by −1), so as to slow down the rate of symbol valid events, until the tracked time offset matches the target value. When the tracked time offset value is higher than the configured target value, (too much lag), further symbol rate modifications are applied with positive sign, so as to fasten the rate of symbol valid events, until the tracked time offset matches the target value. It will be obvious to a person skilled in the art of signal processing that variations on the circuit are possible, such as applying the modified symbol rate only in a predetermined fraction of the clock cycles, which is equivalent to scaling the configured adjustment rate of the time offset by said fraction.

The proposed technique for time adjustment has the following advantages with respect to the prior art where a configurable interpolator (also known as resampler) is inserted after a conventional pulse shaping filter. Firstly, the timing adjustment is here realized without extra signal processing operations in the signal path of a digital transmit filter, meaning that the complexity of an additional weighted combination of symbols or samples is avoided. Secondly, a very low complexity means is provided for smooth timing adjustment that avoids a need for fast updating of the control setting of an interpolator or resampler.

As will be discussed in more detail later, advantageously, the bounded transmit time differences in the transmitter are configured in the transmitter to achieve sufficient alignment, typically arrival time differences of the nominally time-aligned fields or symbols to within 15% of a symbol period among that terminal's carrier of interest and interfering carriers reaching the same terminal. The non-estimation frames 101 in between the estimation frames on the contrary do not need to be time-aligned (but they can be time-aligned if that is convenient, e.g., to have a more simplified transmitter design). In advantageous embodiments the frames 100 and 101 (see FIG. 7) embed physical layer frames 102. In this invention, the frames are superframes as standardized in ETSI EN 302 307-2 and the accompanying guidelines ETSI TR 102 376-2 V1.2.1 (DVB-S2X).

The estimation frames and non-estimation frames of the set of frames each comprise at least an amount of known symbols (although depending on configuration). Optionally they further comprise data symbols. In practice, most frames indeed comprise actual data symbols. In estimation frames, the known symbols at least comprise one or more pilot fields 103 each made up of a sequence of pilot symbols. See FIG. 7. In addition, in estimation frames, the known symbols also comprise a large block of known symbols, typically at the start of the frame (e.g., comprising the start of superframe field in the case of DVB-S2X). In the prior art, a signature is defined comprising both one or more pilot fields and said start of superframe field. An example can be found in the already mentioned application WO2020/021001. The signature in the prior art is not precoded, in contrast to all other symbols in the superframe not belonging to the signature. Channel estimation in the prior art is performed on that signature. In this invention, in many embodiments, one differentiates between pilot fields and the start of superframe (SOSF). Therefore, the large block of known symbols, comprising at least a part of the start of superframe, is referred to as a signature 105. In addition, superframe-aligned known symbol fields for carrier tracking 103, 104 are not part of the signature in this description and are referred to as superframe pilot fields or simply pilot fields. In the description of that prior art document, channel estimation is performed both on the signature field and on the pilot fields. Furthermore, in this description, when reference is made to the use of prior art methods for the channel estimation, the signature is the SOSF and both the signature and the pilot fields are not precoded. Also, the reference scrambling index across interfering carriers is the same. This invention comes with several improvements on this prior art approach. Other fields than 103, 104, 105 that may be present as known symbols include for example known data present in the physical layer frames (e.g. VLSNR pilot fields) comprised in the superframe, without being limited thereto.

Estimation frames, just like non-estimation frames, may carry data to a particular terminal or terminal cluster. As illustrated in FIG. 7, the estimation frames also have a field 105, hereafter called the signature field. In one embodiment, a method known from the prior art is used for channel estimation, like one of the methods referred to in the background section (for example based on non-precoded (super)frame pilots used for carrier reference tracking, or the described digital signals with non-precoded pilots). In another embodiment, pilot symbols in estimation frames are precoded and the signature field is non-precoded. Channel estimation using precoded pilot symbols instead of non-precoded pilot symbols as in the prior art will be explained below. In the possible (although not most preferred) embodiment of this invention wherein all frames are estimation frames, pilot symbols in the pilot field are always precoded.

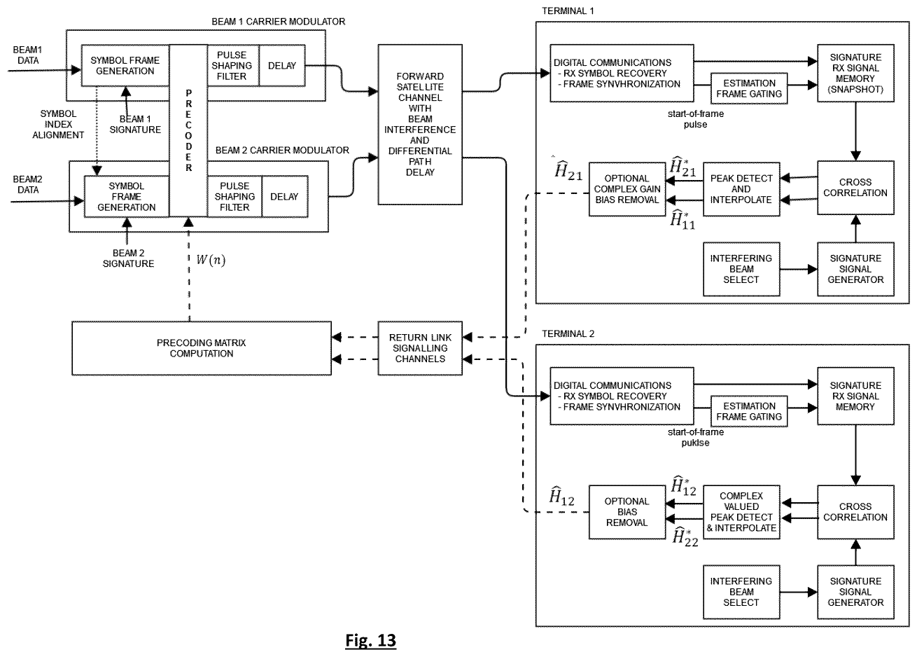

In at least the estimation frames, the signature field is non-precoded. In one embodiment, a method already known from the prior art is used for channel estimation. In a preferred embodiment, the signature field in estimation frames comprises of SOSF plus at least part of the SFFI field, and a signature up to 720 symbols is provided. The non-precoded signature fields are at the receive side of the communication system used for estimating the difference in time offset between an interfering carrier and the receiver's carrier of interest, i.e., for performing the differential time offset estimation. Furthermore, and especially when the pilot fields of estimation frames are precoded, the non-precoded signature fields may play a role in the estimation of the complex coefficients of the channel matrix H (i.e., the channel gains). More precisely, they can advantageously be used when measuring the complex ratio of the non-precoded signature signal of an interfering physical carrier and the non-precoded signature signal of the receiver's carrier of interest. The estimation of channel matrix coefficients and the use of said ratio therein is discussed in detail hereinafter in relation to FIG. 13. As can be seen in FIG. 7, the signature fields and the pilot fields are nominally aligned in the estimation frames of the carriers. By nominally aligned fields is meant that the fields span the same range of symbol indices in all jointly precoded physical carriers. FIG. 7 further also shows the pilot fields 104 in non-estimation frames.

It was mentioned above that different Walsh-Hadamard sequences (identified by a Walsh-Hadamard index) can be used for the SOSF and SF-aligned pilots. The respective Walsh-Hadamard indices are denoted as SOSF-ID and pilot-ID. It was not yet described which SOSF-ID and pilot-ID should be chosen for the estimation and non-estimation frames in the different carriers. Neither it was mentioned if and how the postamble should be used. Further the choice of reference and payload scrambler indices to be used for the estimation and non-estimation frames in the different carriers remains to be elaborated. While the prior art does not distinguish between estimation and non-estimation frames, the prior art solutions are also silent on all these issues, inherently or explicitly assuming that the same SOSF-ID, pilot-ID, reference and payload scramble IDs are used for all frames in a same carrier. The prior art focuses on different IDs across interfering carriers only. In aspects of this invention however, further improvements are specified by better selecting the SOSF-ID, pilot-ID, reference and payload scramble IDs.

Advantageously, the aligned signature fields 105 in the estimation frames in different carriers have near-orthogonal predetermined patterns, in order to allow for channel estimation on the signature 105.

In an embodiment of the invention wherein channel estimation is based on the signature field and SF-aligned pilot symbols are precoded, a same reference scrambler index (across interfering carriers) and different SOSF Walsh-Hadamard indices (across interfering carriers) are used at least among aligned superframes designated as estimation frames.

Two embodiments for non-estimation frames are proposed. In one embodiment a same reference scrambler index (across interfering carriers) and different SOSF Walsh-Hadamard indices (across interfering carriers) are used also in non-estimation superframes. Under alignment of non-estimation superframes and certain receiver carrier of interest processing assumptions (e.g., under a coherent correlation with a predefined scrambled SOSF sequence), this embodiment may benefit from the SOSF orthogonality during acquisition of those non-estimation frames in the carrier of interest. In another embodiment, different reference scrambler indices (across interfering carriers) are used for non-estimation frames. This can prevent false detections under other certain receive carrier of interest processing assumptions. E.g., under non-coherent correlations with a predefined scrambled SOSF sequence during the acquisition of the carrier of interest (e.g., to be able to operate under larger frequency offsets), false lock on non-desired frames (i.e., from another carrier) could arise when the same reference scrambler is used across interfering carriers. As such a false lock would be detrimental, the use of different reference scrambler indices (across interfering carriers) for non-estimation frames is preferred.

The superframe format indicator (SFFI) field is scrambled by the payload scrambler. In an embodiment of the invention wherein estimation frames use a channel estimation method based on the signature field and at least a part of the SFFI is part of the signature field in estimation frames, the payload scrambler IDs in aligned superframes designated as estimation frame are different. Advantageously the payload scrambler ID is selected to provide quasi-orthogonality also of the part of the SFFI field included in the signature and, therefore, of the complete signature field. For example, from the SFFI and payload scrambling definitions provided in the DVB-S2X standard, it follows that in a precoding domain with three physical carriers, payload scramble IDs can be found that provide near-orthogonality of the full 450 symbol SFFI field. Likewise, one can in a precoding domain with four physical carriers identify payload scrambler IDs that provide for quasi-orthogonality of the SFFI field.

All elements of the transmitter of the invention provided above are not limited to a particular superframe format. Even stronger, the proposed solution is not limited to superframes. Any framing structure providing means for a signature and pilot fields is applicable. In the case of superframes, all superframe formats are allowed. Formats 4, 5, 6 and 7 have the advantage not to put a constraint on the scheduling of users or encapsulation as there is no modcod constraint within a superframe (in contrast to formats 2 and 3), thus providing more degrees of freedom (and thus more optimal resource usage in general and less implementation headaches) than formats 2 and 3. In order to time-align at least the estimation frames (to render them suitable for performing channel estimation), the estimation frames have to respect a predetermined superframe length. In that respect format 5 offers the advantage that it can fragment PLFrames across superframes, thus not requiring padding to adhere to that length. In addition, format 5 provides means to signal two SFH application defined bits which is used in one particular embodiment of the present invention (but is not always required). On the other hand, format 6 provides for more robustness as it has a larger fixed preamble (with the fixed EHF for instance). Finally, format 7 comes with less overhead. In brief, the device and method of the invention are not limited to a particular format.

Now the presented frame structure is further specified so that it is particularly suitable for operation with multiple terminals per physical carrier. When attempting to extend the single-terminal per carrier (STPC) case as set out above to a scenario with multiple terminals per carrier several issues occur. There are for example challenges in terms of waveform syntax choice, flexible scheduling of terminals with different channel conditions and traffic needs, organizing of the precoding matrix updates and performing receiver synchronization on the shared carrier.

As mentioned in the background, a single precoding matrix could be used for a group of terminals in a cluster, which is called multicast precoding. While multicast precoding can be applied (as it only impacts the computation of the precoding matrix W based on different channel estimations made by the different terminals), it has the disadvantage that typically the precoding gain reduces and is less predictable. In addition, it needs to be decided which terminals are grouped in a same cluster. Multicast precoding should not be confused with multi-terminal-per carrier (MTPC) precoding. It turns out that, even with unicast precoding, it is conceptually still possible to serve multiple terminals per carrier by multiplexing their data symbols onto a same carrier and then update the precoding matrix whenever a terminal identity changes in at least one of the jointly precoded carriers.

Therefore, an improvement is provided here. In a first step, the number of terminals that can be served by a precoded carrier, can be increased while keeping the concept of unicast precoding. More specifically, each cluster of one or more terminals demodulates and decodes frames which are precoded by a dedicate precoding matrix for that cluster of terminals. In a first instance, those clusters only have one terminal, in which case this corresponds to unicast precoding. Only when the maximum number of clusters has been reached, multicast precoding must be used (by having more than one terminal per cluster) to multiplex frames to more terminals in the same physical carrier. First it is explained below how clusters can be multiplexed each with their dedicated precoding matrix. This is innovative with respect to the prior art, as it allows keeping the highest performance of unicast precoding while still serving more than one terminal per carrier.

By definition, a terminal locks (synchronizes, equalizes, tracks the gain) on frames precoded for that terminal as the frames comprise data for it. In the context of a multi-terminal per carrier scenario, it is however to be avoided that the terminal lock on frames within the same carrier which are precoded for another terminal. Those other frames are not expected to have the same lower interference as the frames precoded for the terminal under consideration itself. Thus, in case the terminal would “lock” on those other frames, it would suddenly experience different link quality estimations, which may confuse many processes (like adaptive coding and modulation (ACM) to name just one). Furthermore, the carrier level and carrier phase for those other frames may also suddenly be different compared to the frames precoded for the considered terminal itself. This could potentially confuse the level control loops, the synchronization and equalization, possibly with impact on the performance for the ‘own’ precoded frames, as the state machines of the level control loops, synchronization and equalization may have too slow time constants. It is thus to be avoided that a terminal lock on frames precoded for another terminal. The prior art however is completely silent on this point.

There is also a requirement that the proposed solution be usable by affordable (e.g., chip based) receivers. The solution according to this invention proposes therefore to leverage a structure which was introduced for a completely different context, namely beam hopping. In beam hopping, a satellite consecutively, in time, illuminates different beams. Hence, a terminal in one beam only sees the carrier illuminating it from time to time. In that time period, the terminal has to burst demodulate the frames transmitted for it. E.g., in the case of superframes, the large superframe preamble allows a terminal to acquire and demodulate the first superframe it sees with nearly no performance degradation. As reference receivers implementing DVB-S2X implemented this capability, the inventors propose to leverage this for precoding. Note that precoding is completely different from beam hopping. In precoding a terminal sees a continuous carrier. In beam hopping, there is no frequency reuse like for precoding, no interference to be estimated. The inventors, however, propose that a terminal only locks on the frames precoded for that particular terminal and not on other frames intended for other terminals. To achieve that, the probability to falsely lock on the other frames needs to be minimized. Note that this challenge is not present in beam hopping as the transmissions to the other beams are not seen by the considered terminal. The aim can be realized as follows. Firstly, per superframe, only one satellite network is served and only one precoding matrix is applied for that satellite network and thus for that superframe. Thus, the precoding matrix in the gateway is updated only at some superframe boundaries (when a next superframe will contain data for at least one other terminal than the preceding superframe). Secondly, some different parameters are chosen for superframes precoded with another precoding matrix. Two ways can be distinguished, depending on the receiver architecture. Under certain receiver processing assumptions (e.g., under a coherent correlation with a predefined scrambled SOSF sequence during acquisition in the carrier of interest), a different SOSF Walsh Hadamard index for superframes precoded with another precoding matrix can be sufficient (hence, the reference scrambler index could be the same). Under other certain receiver processing assumptions (e.g., under non-coherent correlations with a predefined scrambled SOSF sequence during the acquisition of the carrier of interest), different reference scrambler indices are used for superframes that are precoded with another precoding matrix. Thus, at least one of the SOSF-ID or the reference scrambling index is taken different for superframes precoded with another precoding matrix. Satellite networks within a carrier and across interfering carriers are thus configured with a dedicated pair of an SOSF-ID and reference scrambling index, allowing them to lock on the corresponding precoded superframes intended for the respective terminals in that satellite network. For both receiver architectures, a different payload scrambler is of interest, as the SFFI (and in the case of format 5, the SFH, and in the case of format 6, the EHF and PLI) could also be used for acquisition of the carrier of interest. Under a different payload scrambler per satellite network those scrambled sequences are different within a carrier and across interfering carriers, minimizing the probability of false detection on another satellite network.

In a preferred embodiment, there is only one terminal per satellite network, leading to unicast precoding. However, the extension to more terminals per satellite network can be made if more terminals need to be served by the same carrier. In addition, just like for beam hopping, it is advantageous, and may be required depending on the receiver architecture, to include a postamble (available in formats 5, 6 and 7) at the end of a superframe when a new superframe starts that will be precoded by another precoding matrix. This postamble can indicate to the receiver tracking the current frame, that the end of the “serving” has arrived and it can re-enable its correlator to find a new preamble matching with its configured pair of an SOSF-ID and reference scrambling index. The prior art has been completely silent on the introduction of a dedicate pair of an SOSF-ID and reference scrambling index per satellite network and the possible introduction of a postamble in the context of precoding.

The above-described approach has limitations on the number of satellite networks to cluster when not using the concept of estimation frames. More specifically, the near-orthogonality of the scrambled SOSF fields is often not achieved under certain non-coherent receiver architectures in reference receivers.

It is important to note that cost efficient receiver architectures comprise a non-coherent correlation structure in the acquisition unit to acquire the start of a superframe (comprising at least the scrambled SOSF field). More specifically, receivers typically use the first 720-symbol section of the superframe for acquisition, so both the SOSF and SFFI field. As a receiver demodulator gets configured with a particular SOSF index, superframe format, reference and payload scrambler index, the scrambled SOSF and SFFI fields are thus known to the receiver. Because of the presence of a frequency offset of the actual received carrier central frequency with respect to the configured central frequency, full-coherent detection is not possible. Several correlation schemes are available to detect the superframe with frequency offset. A very attractive cost-effective correlation scheme breaks the 720-symbol section in consideration into K S-symbol subblocks. In each subblock, S symbols are coherently correlated with the corresponding known symbols. Then K correlation results are noncoherently combined to form a detection variable. For instance, for the corner case of 1.5%-symbol rate frequency offset, (KS)=(48, 15) is a suitable choice.

The near-orthogonality of the scrambled SOSF fields is, for many SOSF indices, not achieved under the above-described non-coherent receiver architectures in reference receivers. It can actually be shown that for a subblock length of S=15, at most 15 SOSF-indices can be found which have good correlation properties between each other under scrambling by the same reference scrambler. Above was explained, however, that all satellite networks within a carrier and across interfering carriers are to be configured with a dedicated pair of an SOSF-ID and reference scrambling index. Also was pointed out that the reference scrambling index must be the same for frames on which channel estimation is performed. Without the concept of estimation frames, any frame can be used for channel estimation. For a subblock length of S=15, this would result in at most 15 different satellite networks within a carrier and across interfering carriers, which can be sufficient for some applications (e.g., single user per beam applications) but is in certain other applications not enough. The estimation frames as proposed in this invention (also improving the SNR in non-estimation frames) provide an additional advantage to this problem. As channel estimation, for all satellite networks, is only performed on the same set of estimation frames, one can perform precoding over at most 15 carriers (which is more than sufficient for most applications of interest), where each of those carriers use a different SOSF-ID within a set of 15 quasi-orthogonal SOSF-indices under non-coherent correlations. For the non-estimation frames, the reference scrambling index across interfering carriers is not needed to be the same as no channel estimation is performed for those frames. Therefore, the correlation properties of the scrambled SOSF-IDs for different reference scramblers are much improved compared to the correlation properties with the same reference scrambler, minimizing false lock probabilities on another satellite network.

In the invention the signature and, optionally, the pilots are not precoded in estimation frames. Therefore, the SNR estimation and receiver performance for the reception of the non-estimation frames are improved by avoiding that one or more demodulators tasked with demodulation and decoding of user data in non-estimation frames (in a preferred embodiment only those non-estimation frames precoded for the terminal) also lock on estimation frames. The reasons for doing so are the same as mentioned above, i.e., not to confuse synchronization or tracking for instance. This can be achieved in the same way as was described before for distinguishing superframes for different terminals, namely by reserving a dedicate pair of an SOSF-ID and reference scrambling index, disjunct from other pairs used for non-estimation frames within the same carrier. In addition, also a postamble can be included at the end of an estimation frame when the next frame is a non-estimation frame.

A terminal receiver performing channel estimation can thus have one or more demodulators configured with the dedicated pair of SOSF-ID and reference scrambling index for estimation frames, thus only locking on estimation frames. A terminal performing user data demodulation can have one or more demodulators configured with the dedicated pair of SOSF-ID and reference scrambling index for the satellite network it is part of. A terminal can perform both channel estimation and user data demodulation, but the invention is not limited thereto. At least one terminal per satellite network has at least one demodulator locking on estimation frames, to provide channel estimation for that satellite network.

It can thus be desired (for example, in the context of multicast precoding, if not every terminal does channel estimation) for those terminals doing channel estimation and data demodulation, to require at least two demodulators, where a set of one or more demodulators is tasked with channel estimation, and therefore lock at least on the estimation frames, and another set of one or more demodulators is tasked with demodulation and decoding of user data and therefore locks at least on the non-estimation frames.

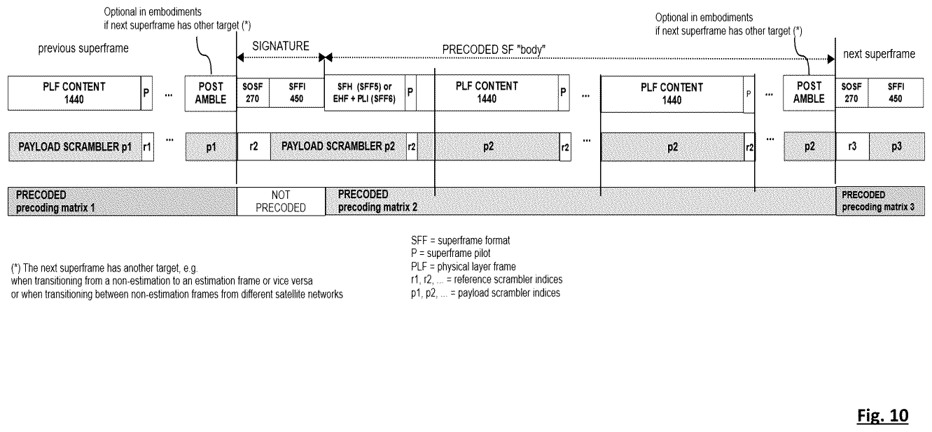

FIG. 10 shows a frame structure for an estimation frame visualizing several features elucidated in this disclosure. Indeed, in an embodiment the signature of an estimation frame is not precoded and the rest of the superframe (including pilots) is precoded. In an embodiment, an estimation frame is inserted from time to time and is preceded and followed by a non-estimation frame. In an embodiment where the receiver has a separate demodulator to lock on non-estimation frames and a separate demodulator to lock on estimation frames, inserting a postamble before transitioning to an estimation frame and when transitioning from estimation to non-estimation frame facilitates this with reference receivers. Also, to prevent false detections, a different reference scrambler can be taken for non-estimation and estimation frames, hence reference scramblers r1 and r3 are different from r2 in FIG. 10. Furthermore, if the next and previous superframe belong to other satellite networks, r1 can also be chosen different from r3. Advantageously, also the payload scramblers p1, p2 and p3 are different In FIG. 10.

As will be obvious to a person skilled in the art of high data rate satellite communications, the Multiple Terminals Per Carrier formalism as set out above may also be used as a technique for achieving extremely high data rates towards certain terminal terminals, in the same vein as the slicing approach considered in DVB-S2X Annex M. However, while in Annex M the slices are defined by a TSN field in the PLFrame header, the slices are then defined by value of the scrambled SOSF field (defined by the SOSF WH index and the reference scrambler ID).

In one aspect the invention relates to a satellite communication system comprising a transmitter as described above. It is repeated here that the transmitter may in some embodiments be part of a gateway, whereas in other embodiments the transmitter may be located in a regenerative satellite. The satellite communication system further comprises one or more terminal receivers.

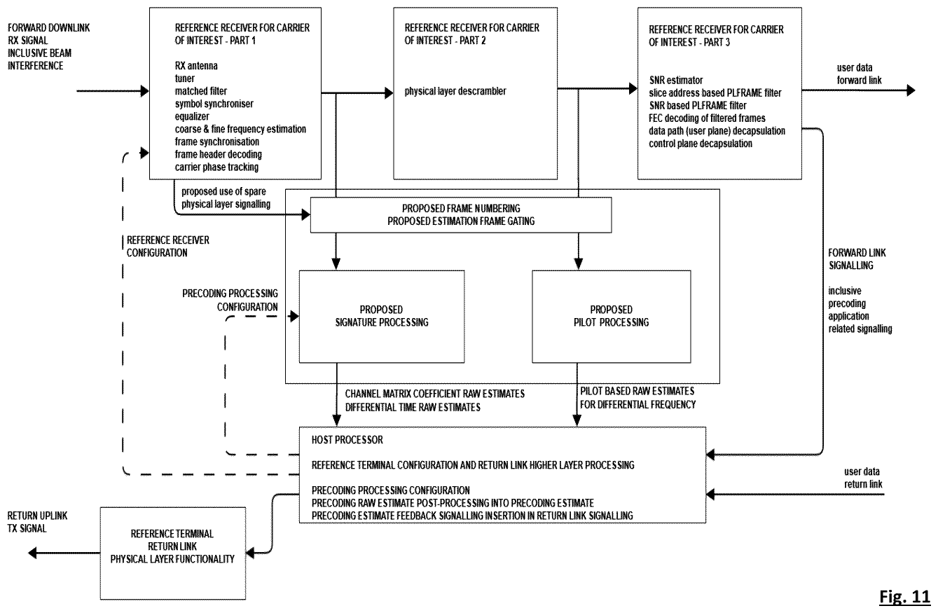

FIG. 11 illustrates a terminal adapted for realizing the forward link linear precoding as described above. In FIG. 11 a reference receiver is considered for a suitable forward link communications standard as a given and it is indicated where the precoding related functionality fits in. Forward link Reference Receiver architecture and implementation guidelines are provided for example in DVB-S2—Guidelines TR 102 376-1 V1.2.1 and in DVB-S2x—Guidelines TR 102 376-2 V1.2.1. The reference receiver is therefore considered to not yet contain any of the precoding related infrastructure discussed in section C.5 of DVB-S2x—Guidelines TR 102 376-2 V1.2.1. The indicated Part 1 of the reference receiver comprises the functions receive antenna, tuner, matched filter, symbol synchronizer, receive equalizer (optional), frequency offset estimation and removal, frame synchronization, frame header decoding, carrier phase tracking; all the above functions in Part 1 have as object the signal of the carrier of interest, but also modify the signal components corresponding to the interfering carriers. Reference receivers typically have only one sample per symbol available after completing the Part 1 tasks. Therefore, as illustrated in FIG. 11, advantageously, further signal processing according to the invention accepts a signal sampled at only one sample per symbol, i.e., a receive symbol sequence. A first signal processing block according to the invention is called the signature processing block. It provides raw estimates of channel matrix coefficients and raw estimates of differential time between interfering carriers and the carrier of interest. Advantageously, the reference receiver Part 2 function, descrambling for the carrier of interest, has not yet been performed yet at the input of the signature processing block (as it would otherwise have to be undone in the signature processing block). A second signal processing block according to the invention is called the pilot processing block. It provides raw estimates of differential frequency between the signal of interest and interfering signals. Advantageously, descrambling for the carrier of interest, has been performed at the input of the pilot processing block (as it would otherwise have to be added in the signature processing block). The estimations provided by the signature processing block may be performed only on a subset of frames, i.e. on the so-called estimation frames. Likewise, the estimations provided by the pilot processing block may be performed only on a subset of frames. In some embodiments of the invention that subset may be characterized relative to a frame numbering counter. The frame count may be based on in-band signalling inserted in the transmitter and extracted in the reference receiver. The reference receiver Part 3 tasks comprise the remaining tasks for reception of the carrier of interest and may comprise signal quality estimation, for example SNR estimation, PLFrame filtering (gating) based on a slice address, PLFrame filtering based on MODCOD and said signal quality estimate, FEC (Forward Error Correction) decoding of filtered PLFrames, user data decapsulation, or control plane data decapsulation. The raw estimates provided by the signature and pilot processing blocks are in the invention advantageously combined in the terminal in summary estimates to be relayed for further combining with summary estimates provided by other terminals. Typically, that relaying of summary estimates in a terminal is done using return link signalling services of a satellite return link from said terminal. In other words, it is by way of illustration assumed that the proposed solution piggybacks on Higher Layer and Lower Layer Return Link services of a Reference Return link implementation, for example according to DVB-RCS2 Guidelines TR 101545-5 for Higher Layers and TR 101545-4 for Lower Layers.

It was already mentioned previously that the precoded pilot fields of the estimation frames and/or of the non-estimation frames are used for dynamic carrier reference tracking at the receive side.

In this invention, channel estimation is performed on estimation frames. For estimation frames, the signature field is non-precoded. In some embodiments, the SF-aligned pilots can be non-precoded. In some embodiments, estimation frames appear in pairs, with a non-estimation frame in between. The term “orchestration of estimation frames” refers to the process that assures sufficient estimation frames are part of the stream of frames, in the right way (e.g. in pairs). Below is explained that this orchestration can happen in many ways. It is to be noted that the invention is not limited to any of the described ways. Orchestration of estimation frames typically occurs in the baseband processing means, because as of the pulse-shape filtering in the modulation means, there is no notion of “frames” anymore. First a case is considered where only estimation frames are time-aligned but non-estimation frames may not be time-aligned across carriers (see for example FIG. 7). Thanks to the possibility to “shorten” superframes (as explained in DVB-S2X for formats 5, 6 and 7), non-estimation frames from both carriers clearly can be shortened at the moment it is needed to have an estimation frame. The case where all superframes (estimation and non-estimation frames) across carriers are time-aligned is a bit easier as this typically does not require shortening just for the sake of aligning estimation frames. PLFrames may still be fragmented across superframes to adhere to the imposed fixed superframe length. In terms of carrying unknown data symbols, two cases can be distinguished. In the first case, estimation frames may carry unknown data symbols. This can again be implemented in many ways. For instance, in a preferred embodiment, a set of estimation frames within a carrier have a dedicated pair (reference scrambler index, SOSF-ID) different from non-estimation frames and estimation frames in other carriers. So, receivers that want to perform channel estimation and/or retrieve the unknown data symbols in estimation frames, need to foresee demodulation means to lock on the superframes with that dedicate pair (reference scrambler index, SOSF-ID) corresponding to the estimation frames in the carrier of interest. For instance, traffic for one or more satellite networks is sent via the estimation frames and receivers in the one or more satellite networks also retrieve the unknown data symbols via the demodulation means. It may be easier however to serve all unicast traffic via non-estimation frames. It is however possible to serve multi-cast or signalling traffic via estimation frames. For instance, such traffic (multi-cast or signalling) is often encapsulated separately from unicast traffic. Typically, the modulator in the hub can distinguish baseband frames coming from different encapsulators (e.g., based on the incoming UDP port). As such the modulator would be capable of knowing when to use an estimation frame (and thus a superframe with the dedicate pair (reference scrambler index, SOSF-ID)) to contain symbols mapped from a part of an input bit stream. Finally, it can be preferred to insert estimation frames in the modulator from time to time, without unknown data symbols (e.g., filling it with a PLFrame obtained from a baseband frame with dummy data bits, e.g., PRBS generated bits; or filling it with one or more dummy PLFrames). In other words, the estimation frames contain PLFrames with data symbols generated from within the transmitter itself (so not generated from unknown data bits provided to the transmitter for modulation). For instance, if an estimation frame is inserted every 50 ms, the overhead can be kept small. For instance, a pair of estimation frames with each a short frame of roughly 3000 symbols at 200 Mbaud takes only 6000 symbols at 1/200 1e-6 seconds, which is 0.03 ms, hence resulting in an overhead of only 0.06%.

In the method as described above estimation frames are advantageously inserted into the set of frames in pairs with at least one frame not being an estimation frame in between the two estimation frames of each pair. This may considerably improve the accuracy of the differential frequency offset estimation, provided that ambiguities can still be still resolved. It will be clear to the skilled person that the number of non-estimation frames in between the pair of estimation frames may also be increased in consecutive estimation steps, each step providing a more accurate estimate or more accurate pre-compensation, in order to avoid frequency ambiguities in the next step. Such a stepwise procedure can obviously be applied with or without invoking pilot-based frequency estimations in any given step.

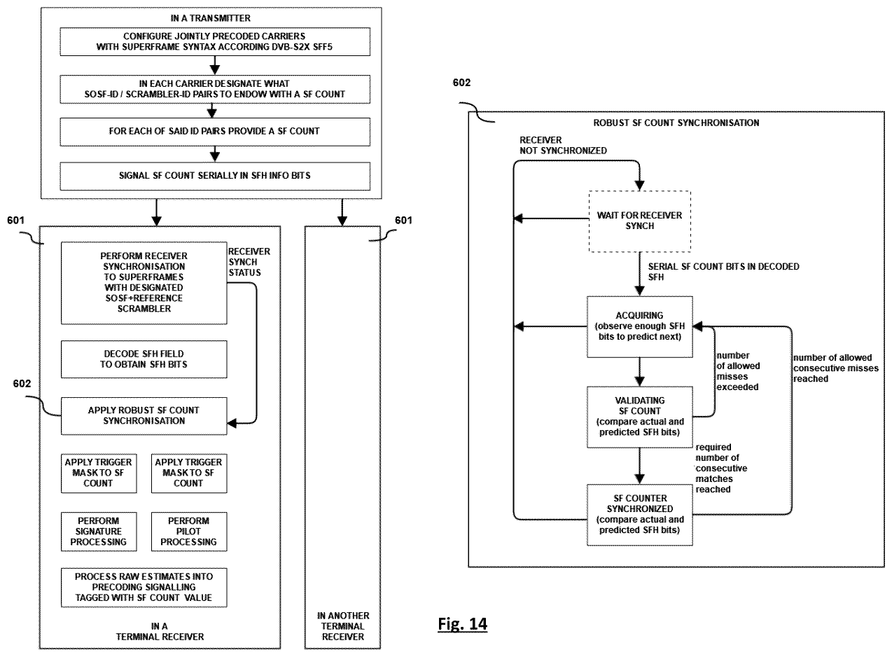

In one embodiment, the estimation frames for above-mentioned frequency estimation methods, are designated with respect to a superframe count signalled by the gateway to terminal. A method for performing said signalling of a superframe count, is disclosed hereinafter and illustrated in FIG. 14, for a DVB-S2X waveform having superframe format SFF5, exploiting two signalling bits per superframe available in the SFH field that the DVB-S2X standard leaves to be defined in proprietary applications.

Based on the signature field, an advantageous method for differential timing estimation (also named delay estimation) can be designed for the satellite communication system considered here, whereby also closed loop pre-compensation by the gateway is achieved.

The required range of differential time estimation, expressed in symbols, and differential delay pre-compensation in the gateway depends on the space segment technology and the carrier symbol rate. The literature mentions ±3 symbols range at 500 Msps for a particular space segment technology. On the other hand, at low symbol rates or for other space segment technologies, performing timing estimation may not be imperative as the time variation would, relatively to the symbol time, reduce to a small fraction of the symbol time.

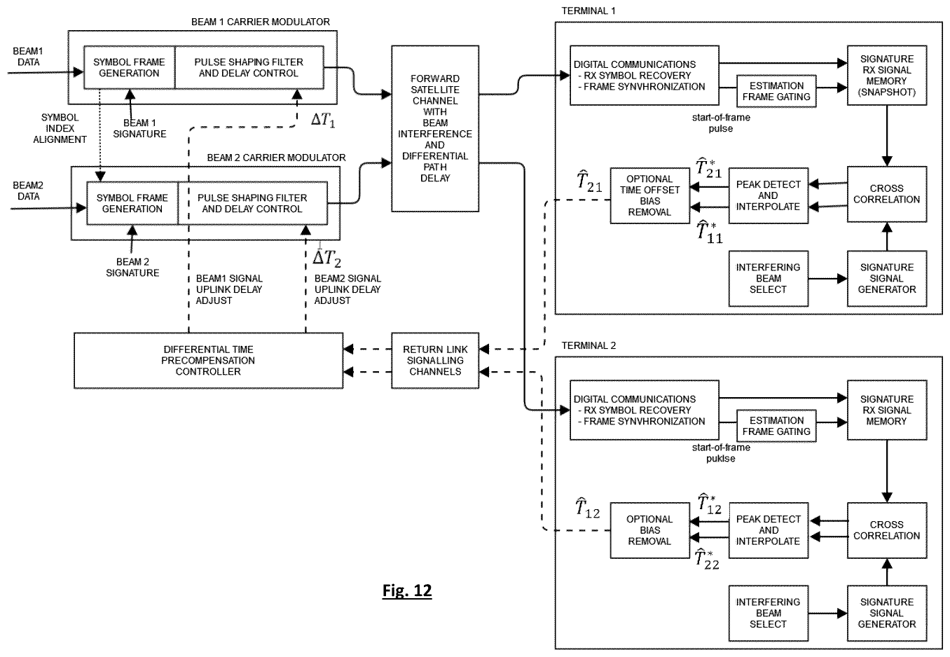

FIG. 12 illustrates a method for differential path delay estimation and closed loop pre-compensation by the gateway. The (simplified) figure shows a satellite communication system with two physical carriers and two terminals. The pre-compensation is based on observations of the signature field in the terminal of interest (terminal 1) and attempts to nullify the differential timing at that terminal 1. Using the example of FIG. 12 the solution for reliable estimation of carrier arrival time differences in a terminal will be explained. Note that the carrier signals are beam signals in FIG. 12.

The modulators for the physical carriers each transmit signature sequences in the estimation frames. The input signal to the terminal receiver contains a weighted sum of the own beam signal and the interfering beam signal. It is assumed that access is available to the receive symbols, already approximately normalized in timing and frequency for the beam signal of interest. By approximately normalized timing is meant that, with a slight modification, a bias can be accepted in the receiver's symbol timing loop induced by the presence of the interferer having an equal symbol rate. By approximately normalized frequency is meant that the time estimation method is not impaired by a residual frequency offset much smaller than the inverse of the signature sequence duration at the point of access. For example, for a signature duration of 1440 symbols a residual frequency offset of ±10 ppm of the symbol rate is considered harmless.

The receiver provides a start-of-frame flag (indicated as start-of-frame pulse in the figure) for the received symbol stream. When the start-of-frame flag occurs, a symbol sequence section covering the receive signature symbols is written in the receive signature memory. As also shown in FIG. 13, this signal is then sequentially correlated with time shifted locally generated resampled replicas of the clean transmit signature signal in an interfering beam, for a number of time offset hypotheses, for example in the range of ±3 symbols with a resolution of ⅛ symbol (49 hypotheses). Peak detection over this range of timing hypotheses is performed, optionally followed by peak argument interpolation near the peak.

This results in an estimate of the beam 2 signal lag compared to the beam 1 signal (signal of interest), denoted as \hat{T}₂₁^{*}. In case the time normalization of the signal in the receiver was not yet accurate, the correlation and peak finding can be repeated for the signature of beam 1 and the bias T_{b}=\hat{T}₁₁^{*} can be subtracted to provide a bias-removed offset \hat{T}₂₁=\hat{T}₂₁^{*}−\hat{T}₁₁^{*}.

The differential time estimates thus obtained in at least a subset of terminals are signalled as feedback to the gateway or centralized gateway or gateway proxy in the satellite, for example using a satellite return link per DVB-RCS2. Based on said signalled differential time estimates the uplink time delay controller computes delay values ΔT₁, ΔT₂, . . . for each of the uplink carriers. A technique for implementing per carrier delay configuration in the transmitter is discussed herein in relation to FIG. 8 and FIG. 9.

In general the signalled time estimates are not fully consistent, for example due to estimation errors, or due to small terminal location dependent differential downlink delays. As an example, the measurement obtained in terminal 1 and terminal 2 about the arrival time difference of the nominally time-aligned carrier 1 and carrier 2 is considered not fully consistent when \hat{T}₁₂≠−\hat{T}₂₁. In that case the uplink time delay controller may, for example, configure the bounded unique values ΔT₁, ΔT₂ that minimize (ΔT₂−ΔT₁+\hat{T}₂₁)+(ΔT₂−ΔT₁−\hat{T}₁₂)². It will be clear to a person skilled in the art that several different optimization criteria and optimization algorithms may be applied for estimating parameters from noisy or inconsistent data, each criterion corresponding to some underlying hypothesis on the statistics of measurement errors or unaccounted for downlink differential delays and some assumed cost of imperfect arrival time alignment. The uplink delay computation may also combine two or more signalled differential delay estimates from the same terminal with weight factors adapted to compromise between denoising effectiveness and agility in the presence of a changing differential time delays in the channel.

In one embodiment, the estimation frames for above-mentioned differential time estimation methods, are designated with respect to a superframe count signalled by the gateway to terminal, according to the invention. A method for performing said signalling of a superframe count, is disclosed hereinafter and illustrated in FIG. 14, for a DVB-S2X waveform having superframe format SFF5, exploiting two signalling bits per superframe available in the SFH field, that are left by the DVB-S2X standard to be defined in proprietary applications.

The approach in FIG. 12/13 is advantageously modified so as to not only interpolate, in the terminal, the time offset argument around the discrete correlation peak but also the complex-valued correlate. This then directly yields, in the context of FIG. 12/13, an estimate of the complex-valued channel matrix coefficient representing the interference from beam 2 to beam 1, here denoted as Ĥ₂₁^{*}.

As with time offset estimation, the receiver may at the point where the receive signature is monitored, not yet have completely normalized the beam 1 signature correlate to a predetermined positive real number. Following a similar approach to removing the differential timing bias, one may remove the ensuing bias on the estimated channel matrix coefficient, by applying the same processing with the signature template for beam 1, resulting in the estimate H_{b}=Ĥ₁₁^{*}. The bias in level and phase to Ĥ₂₁^{*} can then be removed by returning the channel matrix coefficient value as

$${H}_{21} = {\hat{H}}_{21}^{*} / {H}_{b} .$$

In case the normalization by the receiver was reliable, there is no need to perform said complex division but the positive real number, assumed known in the terminal, can just be substituted for H_{b}. Instead of performing the division

$${H}_{21} = {\hat{H}}_{21}^{*} / {H}_{b}$$

directly for each estimation instance, the terminal may obviously also accumulate N estimation values and return a more denoised value

$${H}_{21} = {\sum }_{n = 1}^{N} {\hat{H}}_{21}^{*} / {\sum }_{n = 1}^{N} {H}_{b} ( n )$$

for improved estimation accuracy and reduced signalling to the gateway. Alternatively, the denoising is carried out in the gateway. The denoising formula may also weigh recent measurements higher than earlier once, in order to compromise between denoising effectiveness and agility in the presence of a dynamically changing interference channel.

In one embodiment, the estimation frames for above-mentioned channel matrix coefficient estimation methods, are designated with respect to a superframe count signalled by the gateway to terminal. A method for performing said signalling of a superframe count, is disclosed hereinafter and illustrated in FIG. 14, for a DVB-S2X waveform having superframe format SFF5, exploiting two signalling bits per superframe available in the SFH field, that are left by the DVB-S2X standard to be defined in proprietary applications.

The invention also proposes a method to designate estimation frames in the context of DVB-S2X. There is indeed an interest in identifying the actually used estimation frames among other potential estimation frames and in having a means to share that identification among the terminal receivers or among the terminal receivers and a gateway controller, e.g., for reasons given hereafter. Firstly, when the channel matrix or differential offsets in the satellite channel change as a function of time, advantageously the controllers in FIG. 11 and FIG. 12 combine estimates obtained from the signature and pilot processing performed on time-aligned estimation frames. Secondly, when the delay (for example consisting of processing delay, encapsulation delay, transmission delay, propagation delay, reception delay, network delay) experienced by return link signalling from terminals to a gateway is subject to uncertainty or variation over time and across different terminals, tagging the signalling information with the frame identification informs the gateway of the accurate measurement time irrespective of the delay uncertainty or variation in the signalling channel. The method for identifying the estimation frames as proposed here allows for achieving the desired common understanding between the gateway and the various terminals at the receive side.

Estimation frames are designated by the reference scrambled SOSF and/or by an additional count of superframes in a physical carrier having the same reference scrambled SOSF, and optionally, by a mask or selection applied in the terminal to said superframe count. Note that a terminal receiver for a carrier of interest may only process superframes that match a preconfigured reference scrambled SOSF and skip superframes that do not match the preconfigured reference scrambled SOSF. In that case the count of superframes advantageously increments for each occurrence of the preconfigured reference scrambled SOSF. The mask or selection applied to the superframe count can be preconfigured in a terminal receiver, or alternatively signalled to a terminal receiver, for example using a technique for Forward Link Signalling adopted in the Digital Video Broadcasting standards family. An alternative, less preferred method to designate estimation frames is to convey to the terminal receiver, by means of Forward Link Signalling, both a Network Clock Reference (NCR) and a start time with respect to that Network Clock Reference, of estimation frames. This method is more complex than a superframe count based method since it requires establishing both in the transmitter and the terminal receiver a time relationship between information elements signalled at different levels of a protocol stack.

In a scenario with a single terminal per physical carrier, all superframes on the carrier have the same reference scrambled SOSF. The designation of estimation frames is then, effectively, only based on the superframe count, and optionally on the mask applied to that superframe count.

In advantageous embodiments the superframe count is signalled from the gateway to the terminal in-band, i.e., in fields present in the superframe syntax.

In advantageous embodiments the superframe counter value for the superframes is tagged to the channel state information, the time offset estimation, the frequency offset estimation performed by a terminal and sent to the gateway for precompensation or precoding configuration. The estimation in the terminal is triggered by the reception of the superframe counter information.

In preferred embodiments the period of the superframe count is longer than the above-mentioned uncertainty or variation on the delay (for example consisting of processing delay, encapsulation delay, transmission delay, propagation delay, reception delay, network delay) in signalling of estimation data from terminals to the gateway. Said propagation delay may depend on the position of the satellite and the terminals. The goal is to allow pairing, in the gateway controller the signalled estimation data corresponds to nominally aligned estimation frames.

In other preferred embodiments the superframe count period is even higher to cover additionally the uncertainty of delay in the forward uplink to the satellite. The goal is to allow resolving, in a gateway, what signalled estimation data from the terminals to the gateway is affected by precompensation parameter changes or precoding matrix changes applied earlier in the transmitter.

For SFF5 the available signalling is configurable by the gateway and limited to the two spare signalling bits in the SFH field of the SFF5 syntax. The two signalling bits are defined by the application. Since a 2-bit superframe count (period 4) typically does not allow a unique determination of the superframe that triggered the estimation, there is need to signal a superframe count serially in said SFH bits. Advantageously, the serial signalling is defined so as to obtain a short acquisition or re-acquisition time and a robust performance in the presence of occasional transmission errors in the SFH bits.

In FIG. 14 is illustrated in the left part the process of synchronizing the superframe count among multiple terminals and a gateway, including the step of robust superframe count synchronization 602 taking place in terminals 601. FIG. 14 shows the steps in the transmitter and in each of terminals 601. Note that estimation frames used for signature processing and pilot processing may be optionally separately designated by applying a different trigger mask applied to a common signalling of a count of superframes.

In FIG. 14 is illustrated in the right part an embodiment of robust superframe count synchronisation in the terminal. After receiver synchronisation, the superframe count synchronization progresses from acquiring state to validating state to synchronized state. In acquiring state enough SFH bits are collected to uniquely identify the superframe count value, in the absence of transmission errors in the SFH field. Advantageously, the SFH bit signalling sequence is defined so as to allow quick resolution of the unique superframe count, i.e. based on a limited number of SFH fields. For example, the superframe count is the sequence number of a PN code and the signalled SFH bits consist of bits of a feedback shift register generating said PN code. In validating state subsequent SFH bits are then predicted and compared to received SFH bits. In the validating state, when a predetermined number of consecutive matches is detected, synchronized state is reached. When, on the other hand a predetermined number of cumulative mismatches is reached earlier, acquiring state is resumed. In synchronized state prediction of SFH bits and comparison with received SFH bits is also taking place. In synchronized state, when a predetermined number of consecutive misses is reached, acquiring state is resumed.

Prior art solutions may not distinguish estimation and non-estimation frames. Furthermore, as opposed to prior art solutions, the transmitter according to the present invention also precodes the pilot fields 104 in at least the non-estimation frames, i.e. the frames not being used as estimation frames. The precoded sequence of pilot symbols of the non-estimation frames allows performing at the receive side dynamic carrier reference tracking prior to demapping/decoding of precoded symbols in the non-estimation frames. This overcomes the prior art drawback of degraded receiver processing (comprising synchronization, equalization, SNR estimation) when using a mixture of precoded data symbols and non-precoded pilot symbols, as was proposed in the prior art. It is repeated that the carrier reference tracking may comprise carrier phase reference tracking and carrier level reference tracking.

It is to be noted that the potentially precoded pilots P2 in FIG. E.5 in TSI EN 302 307-2 V1.2.1 (DVB-S2X) and ETSI TR 102 376-2 V1.2.1 (guidelines to DVB-S2X) are not suitable for dynamic carrier reference tracking. The reason is that dynamic channel effects such as phase noise and Doppler in the satellite channel require pilot field intervals substantially below 1E4 symbols. The P2 pilots in said FIG. E.5, however, occur at intervals of a physical layer frame bundle, or about 16E4 and 64E4 symbols for short and normal PLFrame transport, respectively. In the digital signal generated in the transmitter disclosed here, the starting boundaries of consecutive pilot fields are less than 10⁴ symbols apart from each other.

Advantageously, also other parts of the known symbols in at least the non-estimation frames are precoded. In embodiments wherein superframes are employed for example, at least a part of a superframe preamble (comprising SOSF, SFFI, and optionally SFH or EHF and PLI) field of the superframe may also be precoded.

The table below illustrates the impact of having the pilot fields and optionally also the start of superframe field precoded. Comparison is made to the prior art solutions in a reference receiver as tested by the inventors. In the prior art, a start of superframe field and pilots are not precoded. SNRs without AWGN are provided to clearly show the impact of the interference on the combination of SNR estimation and receiver performance of a reference receiver. For a case with high interference (the SNR with interference and without precoding any symbol is only 1 dB), the prior art (with precoding applied except in pilots and start of superframe field) only achieves a monitored SNR of 10.5 dB. A method is proposed to perform precoding while pilots can be precoded in at least a subset of the frames, resulting in an improvement of the monitored SNR in said subset to 18.7 dB. Further, also a way is proposed to do precoding while the start of frame field is precoded in at least a subset of the frames, resulting in an improvement of the monitored SNR in said subset to 32 dB. Clearly, the monitored SNR and receiver performance improves when also precoding (part of) the known symbols in at least a subset of the frames.

| | SNR without | | | Pilots and |
|---|---|---|---|---|
| | precoding any | Prior art: Pilots | Pilots precoded | start of |
| | symbol but with | and start of | and start of | superframe |
| Precoding | interference (as | superframe field | superframe field | field both |
| information | a reference) | not precoded | not precoded | precoded |
| SNR monitored | 1 dB | 10.5 dB | 18.7 dB | 32 dB |

It is of course obvious to the expert that precoding a fraction of the pilot fields will already improve the SNR compared to all pilot fields not being precoded. For example, only precoding one pilot field already improves the carrier tracking for the data symbols around it. Precoding two pilot fields improves the carrier tracking for more data symbols, and so on. In one embodiment, at least half of the number of superframe-aligned pilot fields are precoded, which will result in an SNR closer to the SNR of 18.7 dB (where all pilot fields are precoded). In a preferred embodiment, all superframe-aligned pilot fields are precoded.

The sequence of pilot fields 103 in the estimation frames serves as a reference for differential frequency offset estimation between the carrier of interest for a given receiver terminal and at least one interfering carrier. This will be explained in detail further in this description.

In advantageous embodiments the nominally aligned pilot fields 103 in the estimation frames in different physical carriers are picked from a set of near-orthogonal predetermined patterns, in order to mitigate the beam interference impact while estimating the frequency offset. In preferred embodiments the near-orthogonal predetermined patterns are Walsh-Hadamard sequences (optionally extended with some padding to adhere to some desired length constraints); more specifically, pilots from interfering carriers are selected from different Walsh-Hadamard sequences to have orthogonality between pilot sequences from interfering carriers. In an embodiment the Walsh-Hadamard sequences are those as standardized in DVB-S2X.

For estimating a frequency difference between the physical carrier of interest and an interfering physical carrier, many methods described in the prior art and well known to the skilled person are available. In this disclosure however some advantageous methods for differential frequency estimation are explained.

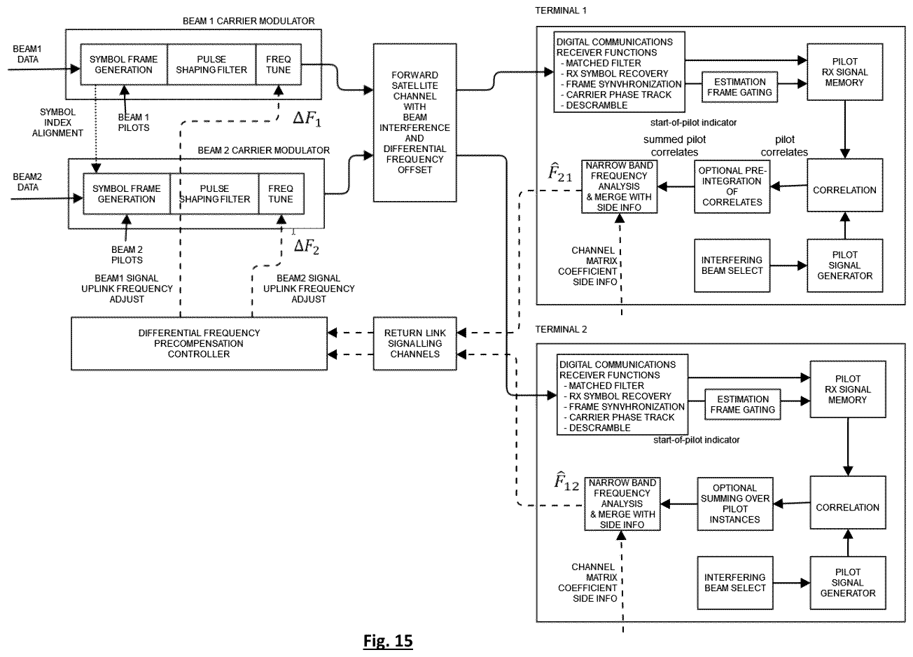

Differential frequency estimation in one or more terminals and pre-compensation in the gateway is illustrated in FIG. 15. In case partial pre-compensation in the gateway is active and takes effect in the signals reaching a terminal, the differential frequency offset being estimated in the terminal may also be referred to as the residual differential frequency offset if one wants to stress that part of the differential frequency offset was already compensated for in the gateway and is no longer observable in the terminal.

The required range of differential frequency estimation, expressed as fraction of the symbol rate, and differential frequency pre-compensation in the gateway depends on the gateway, space segment and gateway technology, orbit type and the carrier symbol rate. Conceivably, in some systems, such as GEO satellite links with extremely accurate reference clocks in the satellite and gateway, differential frequency estimation and pre-compensation may not be imperative.

Differential frequency estimation in a terminal is based either on observation of received pilot fields, on observation of phase changes in an estimated channel matrix coefficient, or on the combination of these information elements. Since channel matrix coefficient estimation is represented separately in FIG. 13, in FIG. 15 the detail for pilot sequence processing is illustrated in the terminal only and the information from channel matrix coefficient estimation is represented as incoming side info. It will be obvious to the skilled person that this combining of information elements may alternatively take place in the gateway, based on the information elements signalled separately to the gateway, without fundamentally altering the invention.

As illustrated in FIG. 15 the receiver for the carrier of interest advantageously provides for matched filtering, receive symbol recovery, frame synchronisation, carrier phase tracking. In some transmission standards, such as DVB-S2X, pilot content is defined as a configurable fixed pattern followed by configurable reference scrambling. In that case, advantageously, reference descrambling is also first performed in the receiver.

One method for estimating the frequency offset between a physical carrier seen by a terminal receiver as the carrier of interest and at least one interfering carrier is schematically depicted in FIG. 15. The received signal comprising a useful signal in the carrier of interest and disturbing signal(s) in the one or more interfering carriers is applied to a matched filter. The matched filter output may then be fed to a reference descrambler as defined in the DVB-S2X standard. The received pilot fields are correlated with prestored or on-the-fly generated clean pilot field patterns. The used pilot field patterns advantageously have been selected from a quasi-orthogonal set, for example the Walsh-Hadamard coded superframe pilot patterns in DVB-S2X. Next, a frequency analysis is performed on a sequence of pilot field correlates or possibly pre-integrated correlates. Many known methods for frequency analysis are available, most of them boil down to computing an approximation of

$$\hat{f} \cdot T = arg {max}_{fT} \vert {\sum }_{n = 1}^{nmax} w ( n ) \cdot c ( n ) \cdot {e}^{- j 2 \cdot π \cdot f T \cdot k ( n )} \vert$$

where c(n) is the correlate for the n-th pilot symbol sequence, k(n) is the average symbol index for said n-th pilot symbol sequence, and w(n) is an optional window function often omitted by setting w(n)=1. As will be clear to a person skilled in the art, the accuracy of frequency estimation from known pilot symbols is subject to errors that depend for example on SNR, on the number of symbols per pilot field and on the distribution of pilot fields as characterized by the sequence k(n). When estimation frames have more than 1 pilot field, then advantageously more than 1 pilot field per estimation frame is included in the above expression for frequency analysis. When all pilot sequences considered have a same length, the average symbol index k(n) may be replaced by the start symbol index of the n-th pilot sequence without altering the expression. The approximation usually consists in first evaluating the expression to be maximized for a discrete set of values fT covering the range of the residual frequency offset, then find the peak expression value in the discrete, then perform some interpolation, e.g., parabolic interpolation around the peak. Some known methods for efficient evaluation are: direct computation (especially when the uncertainty range is small), fast Fourier transform (especially when k(n)−k(1) values have a large common multiple), pruned fast Fourier transform, chirp-z transform. In case the residual differential frequency offset is sufficiently small, advantageously first a pre-integration of a number Nₚᵣₑᵢₙₜ (>1) of correlates is performed, as also indicated in FIG. 15. This means that in the expression above a partial sum

$${\sum }_{n = n 1}^{n = n 1 + {N}_{p r e i n t} - 1} c ( n ) \cdot {e}^{- j 2 \cdot π \cdot f T \cdot k ( n )}$$

is approximated by

$$\{ {\sum }_{n = n 1}^{n = n 1 + {N}_{preint} - 1} c ( n ) \} \cdot {e}^{- j 2 \cdot π \cdot fT {\sum }_{n = n 1}^{n = n 1 + {N}_{preint} - 1}} k ( n ) / {N}_{preint}$$

where

$$\{ {\sum }_{n = n 1}^{n = n 1 + {N}_{p r e i n t} - 1} c ( n ) \}$$

is the quantity referred to above as a pre-integrated correlate.

The pilot-based differential frequency estimation approach need not use all the DVB-S2X pilots. Advantageously, the subset of DVB-S2X superframe-aligned pilots used in the pilot-based differential frequency estimation are either all precoded or all non-precoded. But even if a non-precoded subset is used in the differential frequency estimation, some other SF-aligned DVB-S2X pilots may be precoded in order to improve SNR performance for the carrier of interest. It is also understood that a subset of PLFrames transported within superframes, for example DVB-S2X VLSNR PLFrames, carry may their private pilot fields that are not part of the superframe-aligned pilot structure and that are then typically precoded (as are other PLFrame symbols) and do not take part in the superframe-aligned pilot-based frequency estimation.

The differential frequency estimates thus obtained in at least a subset of terminals are signalled as feedback to the gateway or centralized gateway or gateway proxy in the satellite, for example using a satellite return link per DVB-RCS2. For example, in FIG. 15, terminal 1 signals a representation of the estimated frequency offset \hat{F}₂₁ of the interfering carrier 2 with respect to the carrier of interest 1. Likewise, in FIG. 15, terminal 2 signals a representation of the estimated frequency offset \hat{F}₁₂ of the interfering carrier 1 with respect to the carrier of interest 2. Based on the signalled differential frequency estimates the uplink frequency offset controller computes a transmit frequency offset value ΔFₖ for each of the uplink carriers, here ΔF₁ and ΔF₂ for carrier 1 and carrier 2, respectively. Obviously, techniques for setting and updating a per carrier frequency offset configuration in a transmitter are known in the art and may be applied. Advantageously, the frequency offset configuration updates are applied gently (i.e., in a smooth way) in order not to impair the reception of the carrier of interest in a terminal.

In general the signalled differential frequency estimates are not fully consistent, for example due to estimation errors. As an example, the measurements obtained in terminal 1 and terminal 2 about the arrival frequency difference of carrier 1 and carrier 2 is considered not fully consistent when \hat{F}₁₂≠−\hat{F}₂₁. In that case, the uplink frequency offset controller may, for example, configure the unique values ΔF₁, ΔF₂ that minimize (ΔF₂−ΔF₁+F₂₁)²+(ΔF₂−ΔF₁−\hat{F}₁₂)². It is clear to a person skilled in the art that several different optimization criteria and optimization algorithms may be applied for parameter estimation from noisy or inconsistent data, each criterion corresponding to some underlying hypothesis on the statistics of measurement errors. The uplink frequency offset computation may also combine two or more signalled differential frequency estimates from the same terminal with weight factors adapted to compromise between denoising effectiveness and agility in tracking a changing differential frequency in the channel.

A method to improve differential frequency offset estimation over more than one set of K time-aligned frames across interfering carriers is the following. In the method the change in phase of the corresponding channel matrix coefficient from one estimation frame, denoted A, to a next (and not necessarily consecutive) frame (denoted B) is measured on the signature field as defined in this invention. For example, the differential frequency offset for interfering beam 2 signal can be estimated from observing, in terminal 1, the phase evolution of the corresponding channel matrix coefficient H₂₁ as follows:

$${\hat{F}}_{21} = \frac{R}{2 π} \frac{arg {H}_{21} ( B ) - arg {H}_{21} ( A )}{{N}_{A B}}$$

where \hat{F}₂₁ is the measured frequency offset, R the carrier symbol rate and N_{AB} the symbol index interval from the first estimation frame to second estimation frame. Note that if the range of possible residual frequency offsets is sufficiently large, an ambiguity may arise. For example, assume argH₂₁(B)=argH₂₁(A) is observed, then the actual phase rotation in the interfering signal from signature A to signature B may have been close to 0, consistent with the result F₂₁=0, but it may also have been close to 2nπ, with n integer, consistent with an alternate result \hat{F}₂₁=n.R/N_{AB}. More generally, the ambiguity in the multi-frame signature based frequency estimate can be resolved by additionally performing pilot-based frequency estimation and picking the integer value n for which

$${\hat{F}}_{21} = n \cdot R / {N}_{A B} + \frac{R}{2 π} \frac{arg {H}_{21} ( B ) - arg {H}_{21} ( A )}{{N}_{A B}}$$

is closest to the frequency estimate obtained from pilot processing.

The elements explained above can be used in certain combinations to solve the various technical problems encountered in the prior art as stated in the background section. Hereafter, the solutions to the respective problems are described.

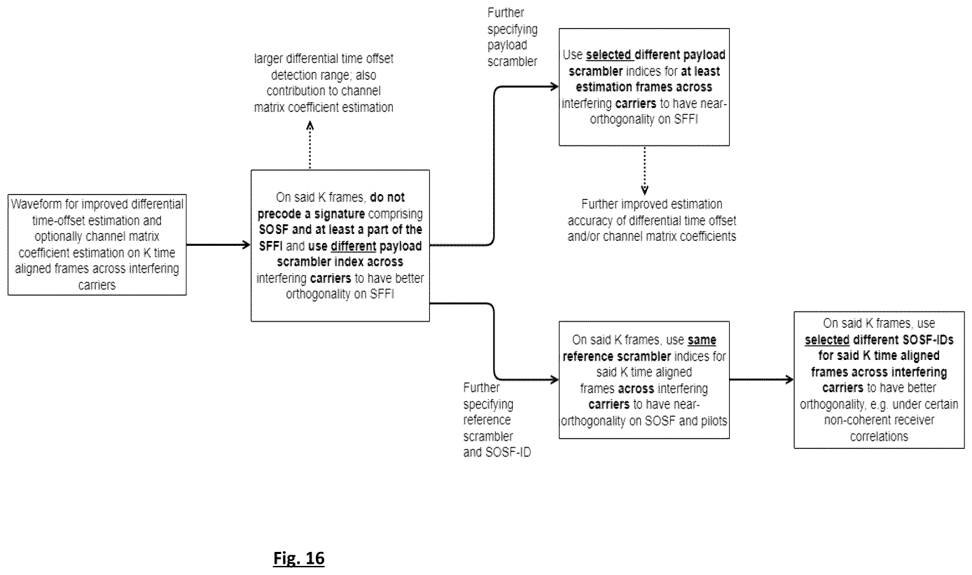

In one aspect the invention relates to a transmitter and method adapted to transmit a waveform for improved differential time-offset estimation and, optionally, channel matrix coefficient estimation on frames across K interfering carriers. The frames are superframes as defined in the DVB-S2X standard. In the set of superframes carrying the stream of symbols to be transmitted there are in each frame one or more physical layer frames and an amount of known symbols comprising at least a SOSF field defined by a SOSF index specific for the superframe in question and a SFFI field. At least a subset of the set of superframes are estimation frames for estimating in the receiver device one or more coefficients of a channel matrix. Each estimation frame comprises a non-precoded signature field. The modulation means perform a superframe specific scrambling of at least the SOSF field with a reference scrambler, whereby the scrambled SOSF field is identified by a reference scrambling index, and a superframe specific scrambling of at least the SFFI field with a payload scrambler, whereby the scrambled SFFI field is identified by a payload scrambling index. The resulting digital signal can be used for performing a differential time-offset estimation based on the non-precoded signature field in the estimation frames. The non-precoded signature field comprises a SOSF and at least a part of the SFFI. The superframe format indicator (SFFI) field is scrambled by the payload scrambler. In an embodiment the payload scrambler ID in aligned superframes designated as estimation frame is selected to provide quasi-orthogonality also of the part of the SFFI field included in the signature and, therefore, of the complete signature field. The different payload scrambler indices across the different carriers yield an improved orthogonality of the SFFI. In some embodiments selected, different payload scrambler indices can be used for at least the estimation frames across the interfering carriers in order to have near-orthogonality on the SFFI. Using the selected payload scrambler indices further allows for an improved estimation accuracy of the differential time offset and, optionally, of the channel matrix coefficients. In other embodiments, apart from using different payload scrambler indices across the K interfering physical carriers, the same reference scrambler indices can be used across the carriers in order to obtain near-orthogonality on the SOSF and on the pilot fields. On the K time-aligned frames across the various carriers optionally selected different SOSF-IDs can be used to have better orthogonality, e.g. under certain non-coherent receiver correlations. In that case, there may only be, for instance, 16 SOSF-IDs that are sufficiently orthogonal amongst each other under the same reference scrambling and with non-coherent receiver correlation. In the case of 4 interfering carriers, only 4 users per carrier could be multiplexed using a single user per superframe unicast precoding method without scheduling constraints which gives optimal throughput gain. This limitation in users is however lifted by using an important aspect of the invention being estimation frames. In that case, user data can be conveyed with non-estimation frames on which no channel estimation is performed. In that case, a different reference scrambler index can be used across carriers in which case all SOSF-IDs can be used. The approach as sketched above is illustrated in the flowchart of FIG. 16.

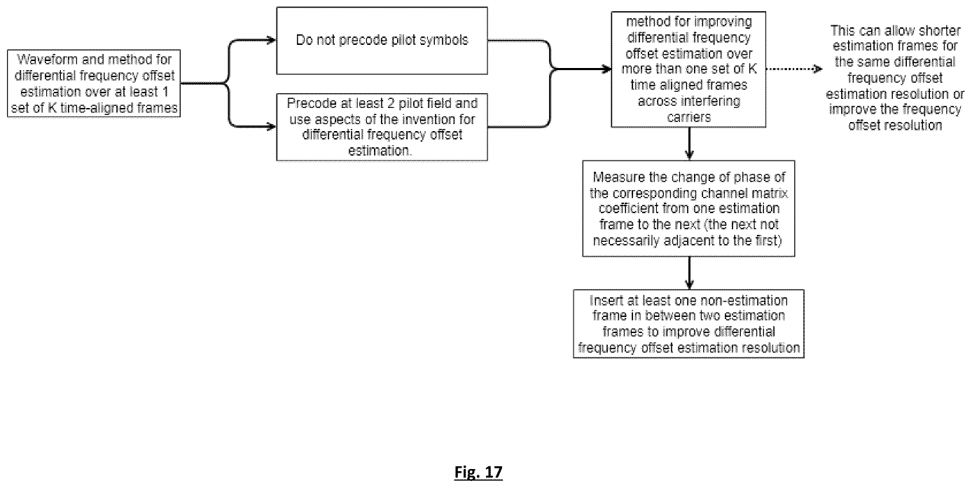

In one aspect the invention relates to a transmitter and method for differential frequency offset estimation over at least one set of time-aligned frames across K interfering carriers. In the set of frames carrying the stream of symbols to be transmitted there is in each frame an amount of known symbols comprising at least a pilot field for performing carrier tracking in the receiver. At least a subset of the set of frames are estimation frames for estimating in the receiver device one or more coefficients of a channel matrix. Each estimation frame comprises a non-precoded signature field. The non-precoded signature fields in the physical carriers are time-aligned. At least a subset of pilot fields in the estimation frames are time-aligned across the physical carriers. In some preferred embodiments the precoding means are arranged for precoding at least either the time-aligned pilot fields in said estimation frames, or, if there are one or more frames not being estimation frames (i.e. non-estimation frames), the time-aligned pilot fields in the non-estimation frames. In an alternative approach one can prefer not to precode the pilot symbols. In both scenarios the method for differential frequency offset estimation can be improved by using more than one set of K time-aligned frames across interfering carriers. The benefit that may result from doing so is that shorter estimation frames can be used for obtaining the same differential frequency offset estimation resolution or that the frequency offset resolution is improved. In a further embodiment one observes the change of phase of the corresponding channel matrix coefficient from one estimation frame to a next frame, which is not necessarily adjacent to the first frame. Advantageously at least one non-estimation frame in between two estimation frames to improve differential frequency offset estimation resolution. The approach as sketched above is illustrated in the flowchart of FIG. 17.

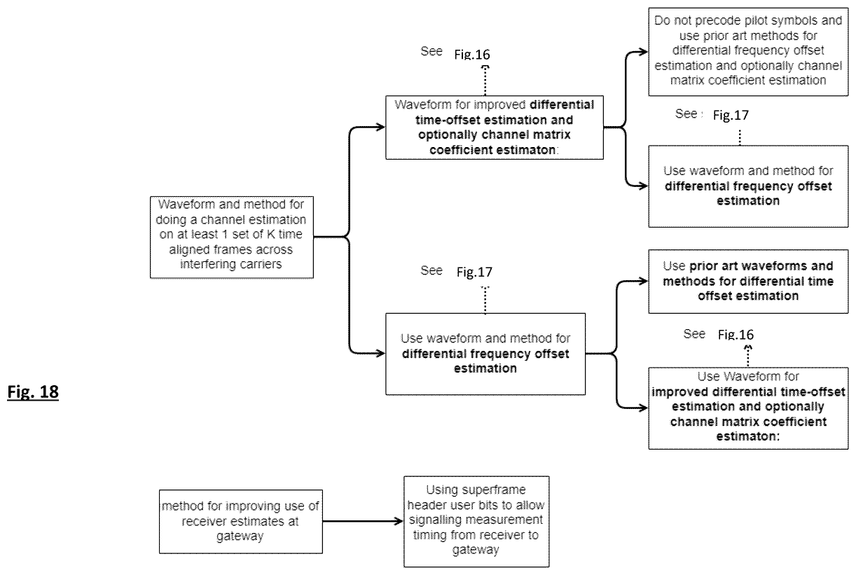

In another aspect of the invention a transmitter and method are presented for performing a channel estimation on at least one set of K time-aligned frames across K interfering carriers. The transmitter produces a digital signal whereby each frame of the set of frames to be transmitted contains an amount of known symbols comprising at least a pilot field for performing carrier tracking in the receiver. At least a subset of the set of frames are estimation frames for estimating in the receiver device one or more coefficients of a channel matrix. Each estimation frame comprises a non-precoded signature field. The non-precoded signature fields in the physical carriers are time-aligned. At least a subset of pilot fields in the estimation frames are time-aligned in the physical carriers. The precoding means are arranged for precoding at least either the time-aligned pilot fields in said estimation frames, or, if there are one or more frames not being estimation frames (i.e. non-estimation frames), the time-aligned pilot fields in the non-estimation frames. As already described previously the digital signal produced by the transmitter can advantageously be applied for an improved differential time-offset estimation. For estimating the differential frequency offset, one can either use precoded pilot symbols and apply the approach as set out above, or one can rather employ a method already described in the prior art. The waveform and method for channel estimation may in preferred embodiments be used for also estimating the differential frequency offset in the way described in the preceding paragraphs. Additionally, it is also possible to perform a differential time-offset estimation with either a method known in the art or the novel method for performing differential time-offset estimation as presented in this disclosure. The approach as sketched above is illustrated in the flowchart of FIG. 18.

In one aspect the invention relates to a transmitter producing a digital signal and a method adapted to improve the digital signal in order to obtain a better SNR estimation and receiver performance for at least the precoded data. The transmitter is arranged to produce a digital signal whereby each frame of the set of frames to be transmitted contains an amount of known symbols comprising at least a pilot field for performing carrier tracking in the receiver. At least a subset of the set of frames are estimation frames for estimating in the receiver device one or more coefficients of a channel matrix. Each estimation frame comprises a non-precoded signature field. The non-precoded signature fields in the physical carriers are time-aligned. At least a subset of pilot fields in the estimation frames are time-aligned in the physical carriers. The precoding means are arranged for precoding at least either the time-aligned pilot fields in said estimation frames, or, if there are one or more frames not being estimation frames (i.e. non-estimation frames), the time-aligned pilot fields in the non-estimation frames.

In some cases, the transmitter does not orchestrate which are the estimation frames to be used for performing the channel estimation and a terminal receiver autonomously selects some frames (some pilot fields) for performing frequency offset estimation. Optionally, the receiver device conveys to the gateway which frames have been selected, for example via the superframe count. Alternatively, the network clock reference can be used. The digital signal for differential frequency offset estimation as set out in the preceding paragraphs can then be applied. Optionally, in further embodiments an estimation of the differential time-offset can be performed, either with the innovative method for time-offset estimation described earlier in this disclosure or by applying a well-known method described in the technical literature.

In other cases, the transmitter does orchestrate which frames can be used for channel estimation. If a superframe count is applied, this can be achieved by providing in each carrier a scrambled SOSF and the superframe count as described above or, alternatively, by conveying to the terminal receivers via forward signalling which subset of superframe count values correspond to an estimation (i.e. indicating which elements belong to the mask being applied). If no superframe count is available, a scrambled SOSF is available and the transmitter conveys to terminal receivers on which matching scrambled SOSF of frames estimation is to be performed. This may be done by making use of the network clock reference. As set out above, in some embodiments superframe header user bits can be used to indicate estimation frames within a carrier. In some embodiments different pairs of SOSF index and reference scramble index can be used for estimation and non-estimation frames. Optionally, a postamble can be inserted before transitioning from an estimation frame to a non-estimation frame and vice versa. In some embodiments, the digital signal for non-estimation frames as described previously can be applied to improve SNR estimation and receiver performance for non-estimation frames. Different options remain available for the channel estimation on estimation frames, either methods commonly known in the art or methods as set out in the present disclosure.

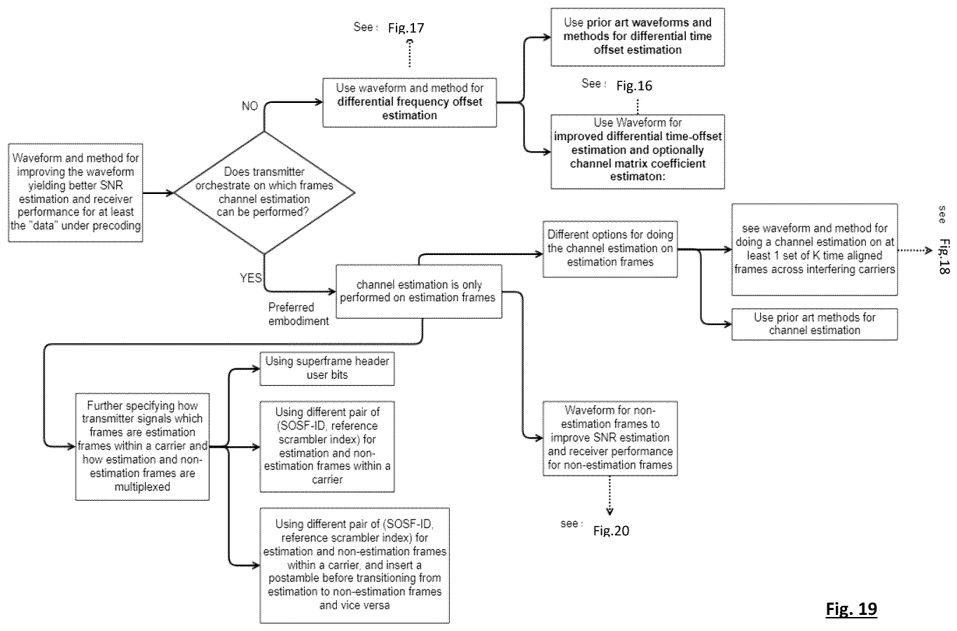

The approach as sketched above is illustrated in the flowchart of FIG. 19.

In another aspect the invention relates to a transmitter for generating for each of at least two physical carriers a digital signal for estimating channel information related to the at least two physical carriers. The transmitter comprises precoding means and modulation means arranged for processing for each of the physical carriers a stream of symbols arranged in a set of superframes as defined in the DVB-S2X standard. The superframes each comprise at least an amount of known symbols and one or more physical layer frames, said known symbols comprising a SOSF field defined by a superframe specific SOSF index. The modulation means are arranged to perform a superframe specific scrambling of at least the SOSF field with a reference scrambler. The scrambled SOSF field is identified by a reference scrambling index. At least a subset of the set of superframes is arranged to perform channel estimation, said superframes of the subset being denoted estimation frames. The estimation frames are time-aligned across the at least two physical carriers. The reference scrambling indices are the same across the at least two physical carriers for the time-aligned estimation frames, and the SOSF indices are different across the at least two physical carriers for the time-aligned estimation frames, whereby each of the estimation frames comprises a signature field, said signature field comprising at least a part of the scrambled SOSF field. At least one superframe not being an estimation frame has a signature field precoded with the precoding means and for each of the physical carriers the digital signal comprises the set of superframes processed in the modulation means.

In some embodiments one or more non-estimation frames comprise a signature field. In some embodiments at least a part of the SFFI and the SOSF comprised in the signature field is not precoded, whereas pilot symbols in the one or more non-estimation frames are precoded. In other embodiments it is the other way round and at least a part of the SFFI and the SOSF are precoded and the pilot symbols are not. In yet other embodiments the part of the SFFI and the SOSF signature fields as well as the pilot symbols are precoded.

In some embodiments the non-estimation frames have a same SOSF index, different reference scramblers and the same payload scrambler across interfering carriers. In other embodiments the non-estimation frames have different SOSF indices, different reference scramblers and same payload scrambler across interfering carriers.

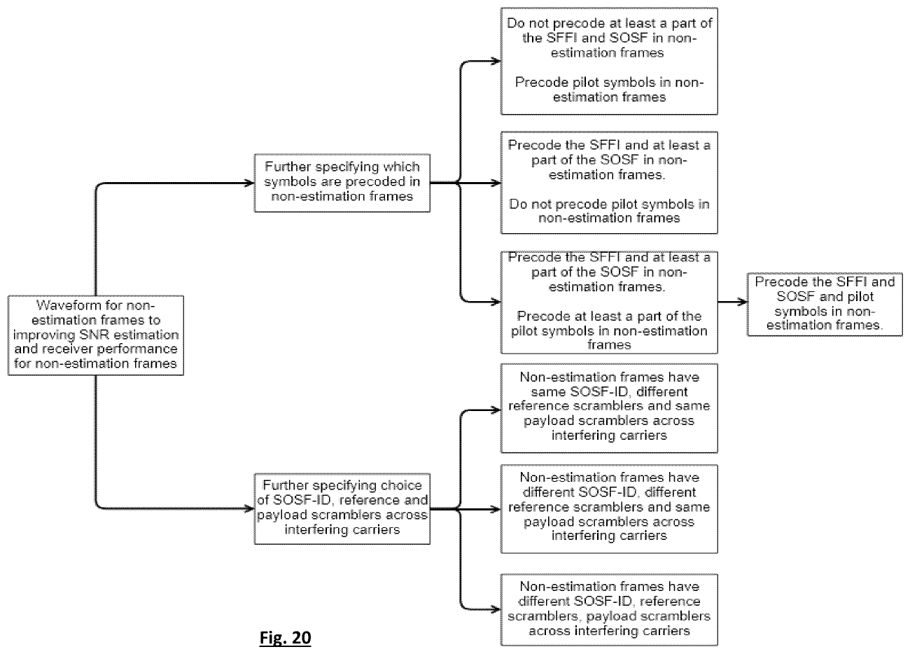

The approach as sketched above is illustrated in the flowchart of FIG. 20.

In another aspect the invention relates to a transmitter arranged for generating a precoded digital signal for each of at least two physical carriers. At least one of the physical carriers has to serve more than one terminal at the receive side. At least one satellite network comprising a plurality of terminals is defined which is to be served by a same physical carrier. For each satellite network a shaper-encapsulator sends baseband frames to the modulator. In some embodiments the shaper-encapsulator sends baseband frames according to a symbol rate to be achieved. That symbol rate can be updated for load balancing reasons. In a particular embodiment only one terminal per satellite network is served.

The digital signal is derived from a stream of symbols arranged in a set of superframes as defined in the DVB-S2X standard. The superframes each comprise at least an amount of known symbols and one or more physical layer frames. The known symbols comprise at least a SOSF field defined by a superframe specific SOSF index. The modulation means are arranged for performing a superframe specific scrambling of at least the SOSF field with a reference scrambler, whereby the scrambled SOSF field is identified by a reference scrambling index. In a superframe only physical layer frames from one satellite network are included. The precoding matrix can be updated when starting a new superframe serving a different satellite network than the previous superframe. Superframes serving a different satellite network have a different preamble. Optionally, a postamble can be inserted before transitioning within a given physical carrier from a superframe for one satellite network to a superframe for another satellite network. Advantageously, from time to time an estimation frame is inserted. Estimation frames are time-aligned across the various carriers. In some embodiments a fixed superframe length is determined in order to achieve the time-alignment of superframes, possible all superframes, across the carriers. When starting a new non-estimation superframe, the satellite network for which the baseband frames are stored the longest ago in the modulator DDR is chosen. Alternatively, when starting a new non-estimation superframe, each satellite network is served in a round robin way.

In the preamble different pairs of SOSF index and reference scrambler index may be used per satellite network within a carrier and across interfering carriers. In some embodiments also a different payload scrambler is used per satellite network within a carrier and across interfering carriers.

A terminal only locks on non-estimation superframes corresponding to its parameters (i.e. SOSF index, reference scrambler index, payload scrambler index). A terminal has at least one separate demodulator only locking on non-estimation frames from one satellite network and not on estimation frames. At least one terminal per satellite network has at least one separate demodulator only locking on estimation frames.

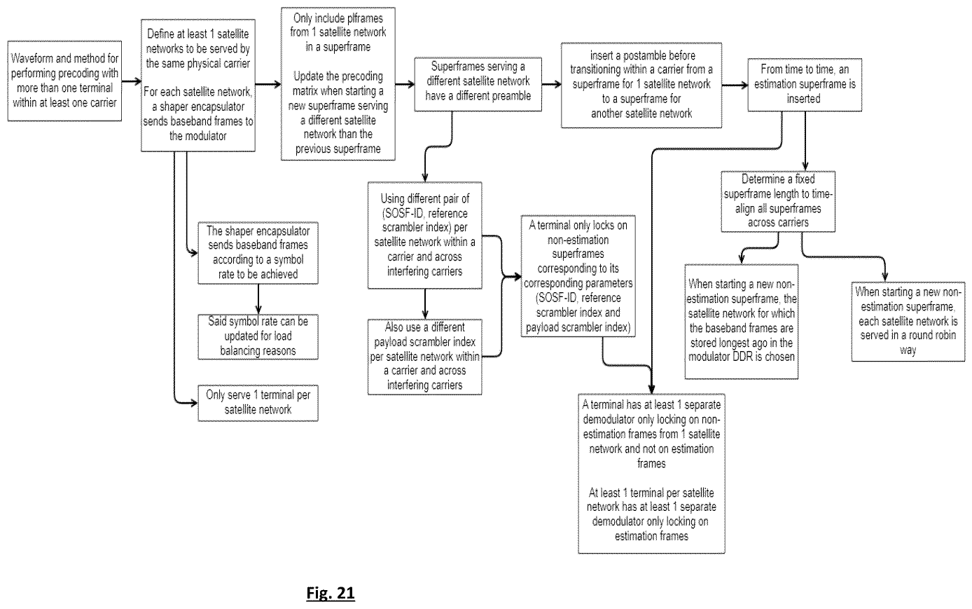

The approach as sketched above is illustrated in the flowchart of FIG. 21.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1.-19. (canceled)

20. A transmitter for generating for each of a physical carrier of interest and at least one interfering physical carrier a digital signal for estimating differential time offset between said physical carrier of interest and said at least one interfering physical carrier,
the transmitter comprising modulation means arranged for processing for each of said physical carriers a stream of symbols arranged in a set of superframes as defined in the DVB-S2X standard, said superframes each comprising at least an amount of known symbols and at least one physical layer frame or physical layer frame fragment, said known symbols comprising a Start-of-SuperFrame, SOSF, field defined by a superframe specific SOSF index and a SuperFrame Format Indicator, SFFI, field, said modulation means arranged for performing a superframe specific scrambling of at least said SOSF field with a reference scrambler, the scrambling sequence being used to scramble at least said SOSF field being identified by a reference scrambling index, and for performing a superframe specific scrambling of at least said SFFI field with a payload scrambler, the scrambling sequence being used to scramble at least said SFFI field being identified by a payload scrambling index,
wherein for each of said physical carriers at least a subset of said set of superframes is arranged for estimating a difference in time offset between said physical carrier of interest and said at least one interfering physical carrier, said superframes of said subset denoted estimation frames, said transmitter further comprising time alignment means to nominally time align all of said physical carriers and a timing precompensation controller arranged to receive information on an estimated time difference between said physical carrier of interest and said at least one interfering physical carrier from one or more terminal receivers, and to adjust time-alignment between said physical carrier of interest and said at least one interfering physical carriers based on said estimated time difference,
wherein said payload scrambling indices are different across said nominally time-aligned physical carriers for said estimation frames,
wherein each of said estimation frames comprises a non-precoded signature field, said signature field comprising at least a part of said scrambled SOSF field and at least a part of said scrambled SFFI field, and
wherein for each of said physical carriers said digital signal comprises said set of superframes processed in said modulation means.

21. The transmitter as in claim 20, comprising precoding means configured for precoding symbols of said set of superframes.

22. The transmitter as in claim 20, wherein said SFFI fields of said time-aligned estimation frames across said physical carriers are scrambled with near-orthogonal patterns taken from a set of predetermined near-orthogonal patterns.

23. The transmitter as in claim 20, arranged for adding a superframe count to designate which frames are estimation frames.

24. The transmitter as in claim 20, arranged for designating which frames are estimation frames by means of said reference scrambled SOSF field.

25. The transmitter as in claim 20, wherein said time alignment means comprises a numerically controlled oscillator to nominally time-align said at least two physical carriers.

26. The transmitter as in claim 20, wherein said time alignment means comprises a configurable interpolator.

27. The transmitter as in claim 20, further arranged to configure said precoding means based on said feedback.

28. The transmitter as in claim 21, wherein at least one superframe not being an estimation frame has a precoded signature field.

29. The transmitter as in claim 20, wherein said reference scrambling indices are the same across said physical carriers for said nominally time-aligned estimation frames.

30. Transmitter as in claim 20, wherein said SOSF indices are different across said physical carriers for said nominally time-aligned estimation frames.

31. The transmitter as in claim 20, wherein said known symbols comprise at least one pilot field for carrier tracking.

32. The transmitter as in claim 20, wherein at least one estimation frame comprises at least one physical layer frame obtained from a baseband frame with dummy data bits or being a dummy physical layer frame.

33. A satellite communication system comprising a transmitter as in claim 20 and at least one set of one or more receivers.

34. The satellite communication system as in claim 33, wherein at least one of said receivers is arranged to add superframe count information to said feedback.

35. The satellite communication system as in claim 33, wherein said superframe count information is derived from a sequence of superframe header fields.

36. The satellite communication system as in claim 33, arranged for changing at least of a SOSF-ID or said reference scrambling index of a superframe for another set of receivers than a preceding superframe and for updating a precoding matrix based on channel information from said other set of one or more receivers.

37. The satellite communication system as in claim 36, wherein said preceding superframe comprises a postamble to indicate that serving of said other set of receivers with said updated precoding matrix is about to start.
